(19) United States
(12) Patent Application Publication
(10) Pub. No.: US 2008/0059846 A1
(43) Pub. Date: Mar. 6, 2008

(54) Fault tolerant electronic trading system and method

(75) Inventors: Leslie Rosenthal, Chicago, IL (US); Benjamin D. Levine, Chicago, IL (US); Samuel Brian Adams, Libertyville, IL (US)

Correspondence Address: Lesavich High-Tech Law Group, P.C., Suite 325, 39 S. LaSalle Street, Chicago, IL, 60603, US

(73) Assignee: Rosenthal Collins Group, L.L.C., Chicago, IL (US)

(21) Appl. No.: 11/897,460

(22) Filed: Aug. 30, 2007

Related U.S. Application Data
(60) Provisional application No. 60/841,925, filed on Aug. 31, 2006.

(51) Int. Cl. G06Q 40/00; G06F 11/07

(52) U.S. Cl. 714/100; 705/37; 714/E11.002

(57) ABSTRACT

A fault tolerant electronic trading system and method. The fault tolerant electronic trading system and method includes N-level redundancy that allows multiple components within the system to fail without forcing users off the system or causing the trading system to fail. Fault tolerance with risk management controls is also provided.

### CROSS REFERENCES TO RELATED APPLICATIONS

This application claims priority to U.S. Provisional Patent Application 60/841,925, filed Aug. 31, 2006, the contents of which are incorporated herein by reference.

### FIELD OF THE INVENTION

This invention relates to providing electronic information via a graphical user interface over a computer network. More specifically, it relates to a fault tolerant electronic trading system and method.

### BACKGROUND OF THE INVENTION

The trading of stocks, bonds and other financial instruments over computer networks such as the Internet has become a very common activity. In many countries of the world, such stocks, bonds and other financial instruments are traded exclusively over computer networks, completely replacing prior trading systems such as “open outcry” trading in trading pits.

Trading of stocks, bonds, etc. typically requires multiple types of associated electronic information. For example, to trade stocks electronically an electronic trader typically would like to know an asking price for a stock, a current bid price for a stock, a bid quantity, an asking quantity, current information about the company the trader is trading such as profit/loss information, a current corporate forecast, current corporate earnings, etc.

For an electronic trader to be successful, the multiple types of associated electronic information has to be supplied in real-time to allow the electronic trader to make the appropriate decisions. Such electronic information is typically displayed in multiple windows on a display screen.

There are however a number of problems with displaying information necessary for electronic trading. One problem is that current Graphical User Interfaces (GUI) are proprietary and do not implement functionality that allow them to be publicly interfaced to existing electronic trading systems.

Another problem is that some current non-proprietary GUIs do not allow a user to subscribe to and receive real-time market data or enter futures orders to all supported exchanges and receive real-time order status updates.

Another problem is that current non-proprietary GUIs do not provide for multiple methods of order entry (e.g., Order Ticket and Aggregated Book View or Ask, Bid, Volume (ABV)).

Another problem is that current non-proprietary GUIs do not provide flexibility for a user to configure the display of electronic trading data. In an ideal implementation, a user would have complete latitude in the combination of types of data to be displayed in a single view.

Another problem is the display of spreads and options. Many GUIs do not display spreads and options.

Another problem is that many GUIs do not provide flexibility for professional traders.

Another problem is most electronic trading systems with GUIs are not fault tolerant if a component of the electronic trading system fails.

There have been attempts to solve some of the problems associated with GUIs used for electronic trading. For example, U.S. Pat. No. 6,938,011, entitled “Click based trading with market depth display” that issued to Kemp et al. teaches “A method and system for reducing the time it takes for a trader to place a trade when electronically trading commodities on an exchange, thus increasing the likelihood that the trader will have orders filled at desirable prices and quantities. Click based trading, as described herein and specifically the “Click” and “Dime” methods of the present invention, enables a trader to execute single mouse click trades for large volumes of commodities at a price within a pre-specified range.”

U.S. Pat. No. 6,772,132 entitled “Click based trading with intuitive grid display of market depth” that issued to Kemp et al. teaches “A method and system for reducing the time it takes for a trader to place a trade when electronically trading on an exchange, thus increasing the likelihood that the trader will have orders filled at desirable prices and quantities. The “Mercury” display and trading method of the present invention ensure fast and accurate execution of trades by displaying market depth on a vertical or horizontal plane, which fluctuates logically up or down, left or right across the plane as the market prices fluctuates. This allows the trader to trade quickly and efficiently.”

U.S. Pat. No. 6,766,304 entitled “Click based trading with intuitive grid display of market depth” that issued to Kemp et al. teaches “A method and system for reducing the time it takes for a trader to place a trade when electronically trading on an exchange, thus increasing the likelihood that the trader will have orders filled at desirable prices and quantities. The “Mercury” display and trading method of the present invention ensure fast and accurate execution of trades by displaying market depth on a vertical or horizontal plane, which fluctuates logically up or down, left or right across the plane as the market prices fluctuates. This allows the trader to trade quickly and efficiently.”

U.S. Pat. No. 6,408,282 entitled “System and method for conducting securities transactions over a computer network” that issued to Buist teaches “The system and method of the preferred embodiment supports trading of securities over the Internet both on national exchanges and outside the national exchanges. The preferred embodiment supports an improved human interface and a continuous display of real-time stock quotes on the user's computer screen. The ergonomic graphical user interface (GUI) of the preferred embodiment includes several functional benefits in comparison with existing on-line consumer trading systems. In the preferred embodiment, the users are subscribers to a securities trading service offered over the Internet. Preferably, each subscriber to this service is simultaneously connected from his own computer to a first system which provides user-to-user trading capabilities and to a second system which is a broker/dealer system of his/her choice. The system providing the user-to-user trading services preferably includes a root server and a hierarchical network of replicated servers supporting replicated databases. The user-to-user system provides real-time continuously updated stock information and facilitates user-to-user trades that have been approved by the broker/dealer systems with which it interacts. Users of the preferred system can trade securities with other users of the system. As part of this user-to-user trading, a user can accept a buy or sell offer at the terms offered or he can initiate a counteroffer and negotiate a trade.”

U.S. Pat. No. 5,297,031 entitled “Method and apparatus for order management by market brokers” that issued to Gutterman et al. teaches “There is provided a broker workstation for managing orders in a market for trading commodities, securities, securities options, futures contracts and futures options and other items including: a device for selectively displaying order information; a computer for receiving the orders and for controlling the displaying device; and a device for entering the orders into the computer; wherein the displaying device comprises a device for displaying selected order information about each incoming order, a device for displaying a representation of an order deck and a device for displaying a total of market orders. In another aspect of the invention, there is provided in a workstation having a computer, a device for entering order information into the computer and a device for displaying the order information entered, a method for managing orders in a market for trading commodities, securities, securities options, futures contracts and futures options and the like comprising the steps of: selectively displaying order information incoming to the workstation; accepting or rejecting orders corresponding to the incoming order information displayed; displaying accepted order information in a representation of a broker deck; and selectively displaying a total of orders at the market price.”

However, none of these attempts solves all of the problems associated with fault tolerant electronic trading systems. Thus, it is desirable to solve some of the problems associated with problems associated with fault tolerance for electronic trading systems.

### SUMMARY OF THE INVENTION

In accordance with preferred embodiments of the present invention, some of the problems associated with fault tolerant electronic trading systems are overcome. A fault tolerant electronic trading system and method is provided.

The fault tolerant electronic trading system and method includes N-level redundancy that allows multiple components within the system to fail without forcing users off the system or causing the trading system to fail. Fault tolerance with risk management controls is also provided.

The foregoing and other features and advantages of preferred embodiments of the present invention is more readily apparent from the following detailed description.

The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exemplary electronic trading system;

FIG. 2 is a block diagram illustrating an exemplary electronic trading display system;

FIG. 3 is a flow diagram illustrating a method for displaying electronic information for electronic trading;

FIG. 4 is a block diagram of a screen shot of an exemplary tools window;

FIG. 5 is a block diagram of a screen shot of an exemplary settings window;

FIG. 6 is a block diagram of a screen shot of an exemplary quotes and contracts window;

FIG. 7 is a block diagram of a screen shot of an exemplary order window;

FIG. 8 is a block diagram of a screen shot of an exemplary fill window;

FIG. 9 is a block diagram of a screen shot of an exemplary position and market data window;

FIG. 10 is a block diagram of a screen shot of an exemplary position and market data window for an order ticket from a sell position;

FIG. 11 is a block diagram of a screen shot of an exemplary position and market data window for a stop order;

FIG. 12 is a block diagram of a screen shot of an exemplary ABV window;

FIG. 13 is a block diagram of screen shot of an exemplary order ticket window;

FIG. 14 is a block diagram of a screen shot of an exemplary reports window;

FIG. 15 is a flow diagram illustrating a method for electronic trading;

FIG. 16 is a flow diagram illustrating a method for processing electronic trading information;

FIG. 17 is a block diagram illustrating an exemplary trading system; and

FIG. 18 is a block diagram illustrating additional details of exemplary trading system;

FIG. 19 is a block diagram illustrating a redundant trading system;

FIG. 20 is a block diagram illustrating an exemplary configuration Entity Relationship Diagram (ERD);

FIG. 21 is a block diagram illustrating an exemplary order management ERD;

FIG. 22 is a block diagram illustrating an exemplary instrument ERD;

FIG. 23 is a flow diagram illustrating a method for fault tolerant electronic trading; and

FIG. 24 is a flow diagram illustrating a method for fault tolerant electronic trading with risk management controls.

### DETAILED DESCRIPTION OF THE INVENTION

### Exemplary Electronic Trading System

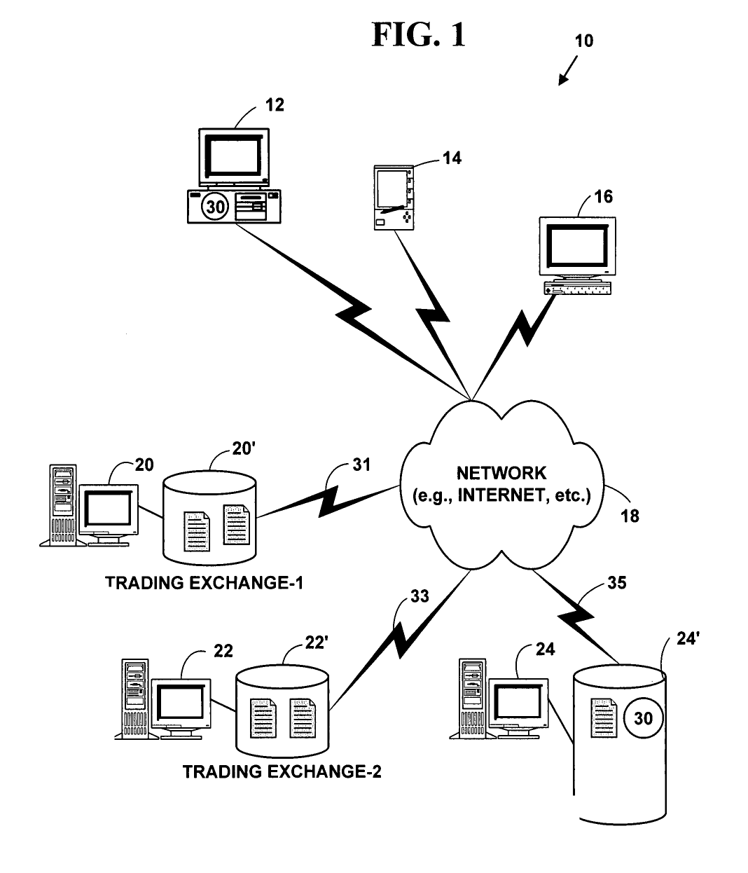

FIG. 1 is a block diagram illustrating an exemplary electronic trading system 10. The exemplary electronic information updating system 10 includes, but is not limited to, one or more target devices 12, 14, 16 (only three of which are illustrated). However, the present invention is not limited to these target electronic devices and more, fewer or others types of target electronic devices can also be used.

The target devices 12, 14, 16 are in communications with a communications network 18. The communications includes, but is not limited to, communications over a wire connected to the target network devices, wireless communications, and other types of communications using one or more communications and/or networking protocols.

Plural server devices 20, 22, 24 (only three of which are illustrated) include one or more associated databases 20′, 22′, 24′. The plural network devices 20, 22, 24 are in communications with the one or more target devices 12, 14, 16 via the communications network 18. The plural server devices 20, 22, 24, include, but are not limited to, World Wide Web servers, Internet servers, file servers, other types of electronic information servers, and other types of server network devices (e.g., edge servers, firewalls, routers, gateways, etc.).

The plural server devices 20, 22, 24 include, but are not limited to, servers used for electronic trading exchanges, servers for electronic trading brokers, servers for electronic trading information providers, etc.

The one or more target devices 12, 14, 16 may be replaced with other types of devices including, but not limited to, client terminals in communications with one or more servers, or with personal digital/data assistants (PDA), laptop computers, mobile computers, Internet appliances, two-way pagers, mobile phones, or other similar desktop, mobile or hand-held electronic devices. Other or equivalent devices can also be used to practice the invention.

The communications network 18 includes, but is not limited to, the Internet, an intranet, a wired Local Area Network (LAN), a wireless LAN (WiLAN), a Wide Area Network (WAN), a Metropolitan Area Network (MAN), a Public Switched Telephone Network (PSTN) and other types of communications networks 18.

The communications network 18 may include one or more gateways, routers, bridges, switches. As is known in the art, a gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another. A switch is a device that filters and forwards packets between network segments. Switches typically operate at the data link layer and sometimes the network layer therefore support virtually any packet protocol.

The communications network 18 may include one or more servers and one or more web-sites accessible by users to send and receive information useable by the one or more computers 12. The one or more servers, may also include one or more associated databases for storing electronic information.

The communications network 18 includes, but is not limited to, data networks using the Transmission Control Protocol (TCP), User Datagram Protocol (UDP), Internet Protocol (IP) and other data protocols.

As is know in the art, TCP provides a connection-oriented, end-to-end reliable protocol designed to fit into a layered hierarchy of protocols which support multi-network applications. TCP provides for reliable inter-process communication between pairs of processes in network devices attached to distinct but interconnected networks. For more information on TCP see Internet Engineering Task Force (ITEF) Request For Comments (RFC)-793, the contents of which are incorporated herein by reference.

As is known in the art, UDP provides a connectionless mode of communications with datagrams in an interconnected set of computer networks. UDP provides a transaction oriented datagram protocol, where delivery and duplicate packet protection are not guaranteed. For more information on UDP see IETF RFC-768, the contents of which incorporated herein by reference.

As is known in the art, IP is an addressing protocol designed to route traffic within a network or between networks. IP is described in IETF Request For Comments (RFC)-791, the contents of which are incorporated herein by reference. However, more fewer or other protocols can also be used on the communications network 18 and the present invention is not limited to TCP/UDP/IP.

### Exemplary Electronic Trading Display System

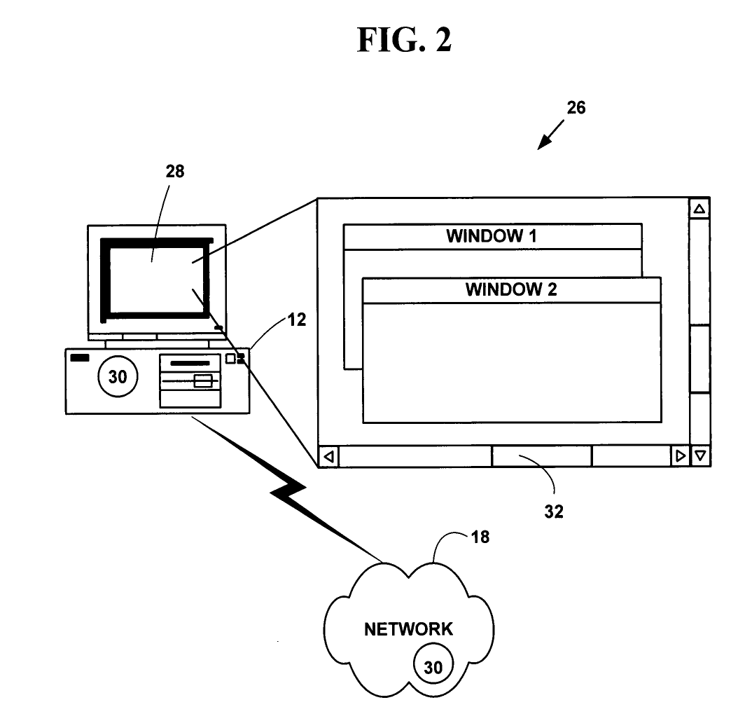

FIG. 2 is a block diagram illustrating an exemplary electronic trading display system 26. The exemplary electronic trading system display system includes, but is not limited to a target device (e.g., 12) with a display 28. The target device includes an application 30 that presents a graphical user interface (GUI) 32 on the display 28. The GUI 32 presents a multi-window interface to a user.

In one embodiment of the invention, the application 30 is a software application. However, the present invention is not limited to this embodiment and the application 30 can firmware, hardware or a combination thereof.

An operating environment for the devices of the electronic trading system 10 and electronic trading display system 26 include a processing system with one or more high speed Central Processing Unit(s) (“CPU”), processors and one or more memories. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It is appreciated that acts and symbolically represented operations or instructions include the manipulation of electrical signals by the CPU or processor. An electrical system represents data bits which cause a resulting transformation or reduction of the electrical signals, and the maintenance of data bits at memory locations in a memory system to thereby reconfigure or otherwise alter the CPU's or processor's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (“RAM”)) or non-volatile (e.g., Read-Only Memory (“ROM”), flash memory, etc.) mass storage system readable by the CPU. The computer readable medium includes cooperating or interconnected computer readable medium, which exist exclusively on the processing system or can be distributed among multiple interconnected processing systems that may be local or remote to the processing system.

### Exemplary Method for Processing Electronic Information for Electronic Trading

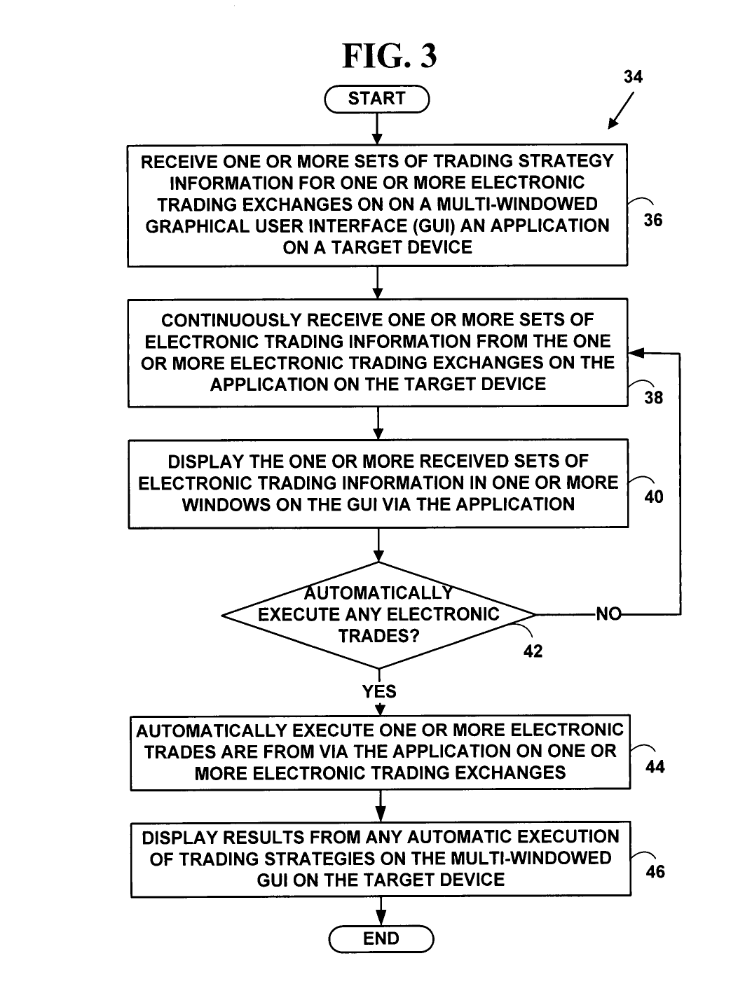

FIG. 3 is a flow diagram illustrating a Method 34 for processing electronic information for electronic trading. At Step 36, one or more sets of electronic trading strategy information is obtained via one or more windows on a application 30 on a target device 12, 14, 16 to automatically execute one or more electronic trades on one or more electronic trading exchanges 20, 22. At Step 38, one or more sets of electronic trading information are continuously received on the application 30 via one or more application program interfaces (API), fixed or dynamic connections from one or more electronic trading exchanges 20, 22. At Step 40, the one or more sets of electronic trading information are displayed in one or more windows on the GUI 32 via application 30. At Step 42, a test is conducted to determine if any electronic trades should be automatically executed based on the one or more sets of electronic trading strategy information. If any electronic trades should be automatically executed, at Step 44, one or more electronic trades are automatically electronically executed via application 30 an appropriate electronic trading exchange 20, 22. At Step 45, results from any automatic execution of any electronic trade are formatted and displayed in one more windows on a multi-windowed graphical user interface (GUI) 32.

In one embodiment the one or more sets of electronic trading strategy includes a pre-determined trading strategy created by a trader, if-then trading strategies, one-cancels-other (OCO) trading strategies and electronic trading strategies for synthetic instruments or synthetic contracts, or execution of strategies based on previously executed orders.

As is known in the art, the pre-determined strategy trading strategy is a pre-determined trading strategy developed by a trader to apply to a desired market (e.g., cash, futures, stocks, bonds, options, spreads etc.)

As is known in the art, a “synthetic” instrument or contract includes an instrument or contract that does not really exist on any electronic trading exchange. A synthetic can be made up of one, or several contracts that trade on an exchange or multiple exchanges. For example, a synthetic contract may include automatically selling a call and buying a put. Such a synthetic contract does not exist on any trading exchange but is desirable to a selected group of traders

As is known in the art, an API is set of routines used by an application program to direct the performance of actions by a target device. In the present invention, the application 30 is interfaced to one or more API.

In another embodiment, the application 30 is directly interfaced to a fixed or dynamic connection to one or more electronic trading exchanges without using an API.

In one exemplary embodiment of the invention, the application 30 interfaces with a Client API provided by Professional Automated Trading Systems (PATS) of London, England, or Trading Technologies, Inc. (TT) of Chicago, Ill. GL Multimedia of Paris, France and others. These APIs are intermediate APIs between the Application and other APIs provided by electronic trading exchanges. However, the present invention is not limited to such an embodiment and other APIs and other fixed or dynamic connections can also be used to practice the invention.

In another embodiment, the application 30 interfaces directly with the electronic trading exchanges 20, 22 without going through a Client API. In such an embodiment, the application 30 interfaces directly with the electronic trading exchanges 20, 22 through an electronic trading exchange API. In another embodiment of the invention, the application 30 interfaces directly with electronic trading exchanges via the communications network 18.

The application 30 presents a user a multi-windowed GUI 32 that implements the functionality exposed through API provided by electronic trading exchanges. The application 30 allows the user to subscribe to and receive real-time market data. Additionally, the application 30 allows the user to enter futures orders, cash orders, and other types of financial products orders to all supported exchanges and receive real-time order status updates. The application 30 supports at least two methods of order entry; Order Ticket and Aggregated Book View (ABV).

The application 30 provides flexibility to the user to configure the display of electronic information on the GUI 32. The application 30 and the GUI are now described in further detail.

### Desktop Layout Management

The application 30 provides the ability to manage Desktop Layouts. A Desktop Layout is a state of a GUI 32 as it appears to a user. This includes, but is not limited to, number of windows, types of windows, and the individual window settings. A user is able maintain a list of available Desktop Layouts. Each Desktop Layout has a unique name within the application 30. The user is able to create a new Desktop Layout and save it, giving it a unique name. When the user saves a Desktop Layout, it is not saved in a minimized state but is instead saved in an expanded state. The user is able to rename, copy, and delete a Desktop Layout. The user is able to load a saved desktop layout, replacing the currently displayed configuration. The application 30 receives and loads desktop layout templates from the communications network 18 upon user login. The user is able to export and import desktop layouts in order to port them from target device to target device. Desktop Layouts are saved on a user by user basis (e.g., by username). If two users access the application 30 from the same target device 12, each user sees their own list of layouts upon login.

The application 30 is launched from target device 12, 14, 16 or via the network 18 (e.g., the Internet, an intranet, etc.) The application 30 is installed on a target device 12, 14, 16 or the communications network 18. Upon startup, the application 30 detects if a new version is available. If the application 30 detects that an upgrade is warranted, a window appears, asking the user if they would like to install the latest version now. In one embodiment, if the user chooses not to install the latest version upon startup, the current (older) version of the application 30 is launched. In another embodiment, another prompt is displayed when the user logs off. In the case of a critical update, the user is not able to choose to run the application 30 without installing the update.

The application 30 is pushed information that determines which servers the application 30 is to connect to. IP addresses or Domain Name Servers (DNS) names are pushed to the client when upon login.

In one embodiment, the application 30 can be used by up to about 5,000 simultaneous users. Scalability allows the application 30 to be used by up to about 20,000 simultaneous users. However, the present invention is not limited to such an embodiment and other embodiments with other numbers of simultaneous users can also be used to practice the invention.

The application 30 indicates the status of a host connection 20, 22, 24 on the communications network 18. As a minimum, “Connecting,” “Connected” and “Not Connected” statuses are indicated. The application 30 indicates the status of an electronic trading exchange server connection 20, 22. As a minimum, “Connecting,” “Connected” and “Not Connected” statuses are indicated for the electronic trading exchange server connection.

If settings (e.g., accounts, contracts, etc.) change on a host system 20, 22, 24, the application 30 updates the settings. The user does not have to log back in to see the changes. The application 30 has the ability to detect if any changes to accounts or contracts have been made. The application 30 is able to detect when a system administrator has changed a network address (e.g., an Internet Protocol (IP) address, etc.) of the primary transaction server for a client.

The application 30 can log off of one network address and log onto another. Data integrity is maintained when a network address change has been made. The application 30 notifies the user of any working orders or open positions before closing. The user has the opportunity to cancel the logout if they would like to cancel working orders or close the open positions. The application 30 performs the normal logoff cycle when closed by the user. The application 30 saves all data needed to return it to the state it was in when the application 30 was closed. The application 30 saves all data necessary to restore it to the current state in the case of a catastrophic application 30 failure. If the user does not choose to download the most recent version of the application 30 upon startup, a message appears upon logoff asking the user if they would like to install the upgrade before closing.

In one embodiment, the application 30 gracefully log users out at end of a day. In another embodiment, the application 30 does not log users out at the end of a day. The user receives a warning message, stating that the session is about to be closed. The user needs to log back in to reestablish the connection. The application 30 allows the user to combine the display of data of different types. Data types include, but are not limited to, Orders, Fills, Positions and Market Data. The application 30 supports the functionality exposed through the current version of a client API.

The application 30 supports data format differences between exchanges that are not normalized by the client API. The application 30 supports differences between exchange order handling semantics that are not normalized by the client API. The application 30 gracefully handles spreads. The application 30 support systems with multiple monitors. All exchange contracts supported by a platform are considered by the application 30. Online user documentation is available to the user. The application 30 runs on Windows 2000, Windows XP, Windows Vista operating systems and other windowed operating systems (e.g., Linux, etc.). The application 30 architecture is flexible in order to allow additional functionality to be added when needed.

### Standard Windows Grid

In a Standard Windows Grid, a user can select from a list of columns to display. The user is able to add or remove columns, but all columns may not be able to be removed and certain columns may need to be added in order to add other columns (if there are dependencies). Each window will have certain columns that appear in the grid by default. The grid has a column heading with a caption (column name).

The user can change an order of the displayed columns by dragging the column heading to a new position. The user can manually resize a column. The user can resize all columns to fit the screen. The user can resize all columns to fit their contents. The user can resize a selected column to fit the column's contents. This is accomplished by double clicking on the column heading's right border. The user can change the foreground and background colors of a column. The user can rename any grid column. The user can restore the default grid column names. The user can restore all default grid settings.

The user can change the font for all columns in the grid. This includes, but is not limited to font type, color and size. The user can change the font for an individual column. This includes, but is not limited to, font type, color and size. The user can sort the data in the grid by clicking on a column heading. The user can sort the data in ascending or descending order. The user can create multiple sort criteria. The user can create a filtered view of the information in a grid. The user can filter on multiple criteria for non-numeric columns. Filters can include more then one column. Multiple filters for numeric columns can be created (e.g., for an =, ≠, <, >, ≦ or ≧ operation, etc.). This functionality also allows the user to choose a range. The user can remove filters from a grid. Data in a grid will continue to be updated while a filter is applied.

### Login Window

In one embodiment, a Login window will be launched via the application 30 when the application 30 is first accessed by the user. A user will enter a user name and password in order to log into the application 30. A successful login will allow the user full access to multi-windowed GUI 32 functionality. A failed login displays a message to the user, indicating that either the user name or password were invalid, but not which one. If Caps Lock is on, the failed login message the application 30 indicates this fact. The failed login message reminds the user about case sensitivity. The user is able to change passwords. The user does not have to be logged into the communications network 18 to change passwords. In another embodiment, the user is not able to change passwords from the Login window. In such an embodiment, a user can change passwords after logging in via the Login window and accessing a network application (e.g., web application). In one specific embodiment, passwords are changed via a network interface via the Reports window described herein.

The application 30 updates a database with the new password. All characters entered into a password field will be visible to the user as asterisks. A single login allows the user access to all supported and enabled exchanges.

### Application Manager Window

An Application Manager Window allows the user to access all of the functionality of the application 30. It is via these windows that other application windows are launched and managed. The GUI 32 windows are automatically launched once the user has successfully logged in. Only one Application Manager window is launched by the application 30.

The Application Manager Window, by default, is a member of every display layout on the GUI 32 and cannot be removed. The user is able to view a list of available Desktop Layouts and select one to work with.

The user can create a new Tools window, Settings window, Contact and Quotes Window, Orders and/or Fills window, Positions/Market Data window, Aggregated Book View window, Order Ticket window and Reports window from the Application Manager Window. The user can also open a saved window from the Application Manager Window.

The user can maintain Desktop Layouts from the Application Manager Window. The user can minimize all windows and restore all windows from the Application Manager Window.

### Client Messaging Window

A Client Message Window allows the user to view system messages, trading exchange messages and alerts. This window is automatically launched once the user has successfully logged in. In one embodiment, only one Client Messaging window may be launched by the application 30. In another embodiment, more than one Client Message windows may be launched by the application 30. The Message display, by default, is a member of every display layout and cannot be removed. Users who are logged on must be able to receive system messages, communications from office personnel, electronic trading exchange messages and alerts from various electronic trading exchanges 20, 22. Alert receipts are displayed for the user. The window displays the entry and cancellation of orders (as messages). Alerts are given a priority, including, but not limited to, of “Critical,” “High,” “Medium” or “Low.”

Alerts of a high priority are presented in a more intrusive manner than lower priority alerts. Upon login, users receive alerts from the current day that were sent while they were logged off. The user is able to turn off the display of alerts and are able to turn off the display of messages.

### Tools Window

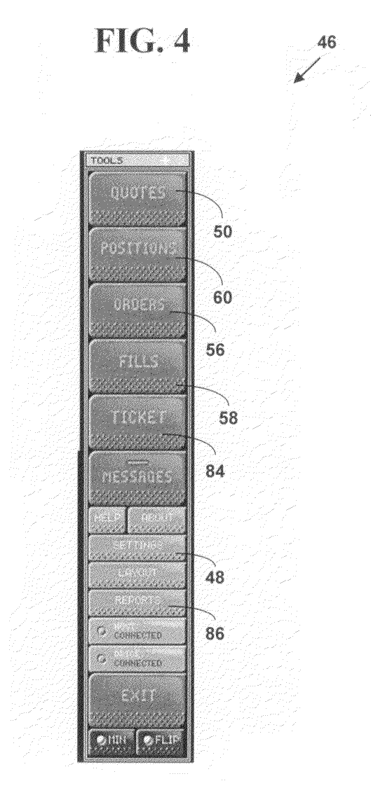

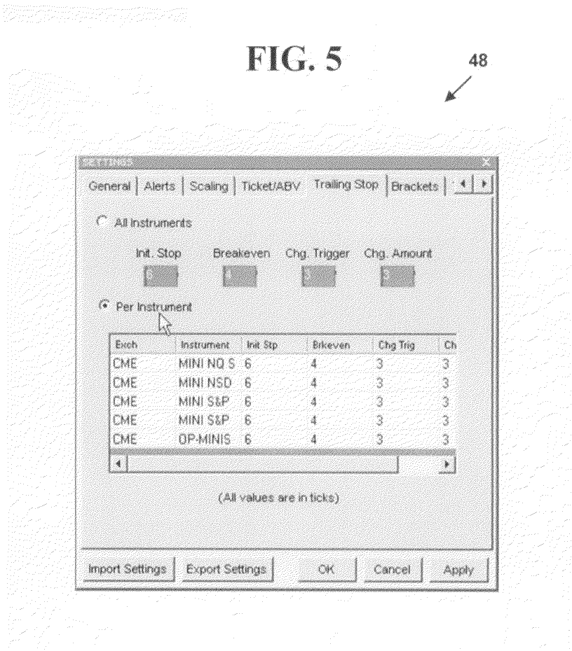

FIG. 4 is a block diagram of screen shot of an exemplary Tools window 46 produced by application 30 and displayed on the GUI 32. The Tools window 46 is used to launch other windows described herein on the GUI 32.

### Settings Window

FIG. 4 is a block diagram of screen shot of an exemplary Settings window 48 produced by application 30 and displayed on the GUI 32. The Settings window 48 allows the user to enter application-wide settings (such as defaults, etc.) This window 48 is accessible via the Manager window. The window 48 is different from any other window in the application. Multiple Settings windows cannot be opened, and this window is not part of a Desktop Layout.

The Settings window 48 displays network address (e.g., local and Internet IP addresses) of a target device 12, 14, 16. The Setting window 48 displays the Host and Price server IP addresses and ports that are being used by the application 30.

In one embodiment, the user loads settings from a settings file via the Settings window 48. The settings file contains information necessary to replicate the configuration of an application, including settings and desktop layouts. For audible alerts, each alert should have a different sound. The user can browse for sound files to assign to events. In another embodiment, settings are loaded from automatically from data structure within the application 30.

The user can turn on or off audible and/or visual alerts for the events listed below in Table 1. However, the present invention is not limited to these audible and/or visual alert events and more, fewer or other types of audible and/or visual alert events can be used to practice the invention.

TABLE 1

Logout
Login
Receipt of a fill
Entry of an order
Entry of an order amend
Entry of a cancel request
Receipt of an order
Receipt of a cancel
Receipt of an amend
Receipt of a reject
Receipt of a message
Order state timeouts
Loss of connection to the host server
Loss of connection to the price server
Reconnection to the host server
Reconnection to the price server
Receipt of SARA alerts
A different sound/visual alert is used for each priority level.
Limit breach
Contract breach
Exchange disabled
Stop price triggered for synthetic stops and stop limit orders
Pull all orders
End of day/End of market
By exchange
This information is downloaded on login if an update is needed.
Custom Reminders
OCO fill
OCO cancel
Parked order violated
If Then fill
If Then cancel
P/L bracket fill
P/L bracket cancel

The user can set the following defaults for an order ticket listed in Table 2. However, the present invention is not limited to these defaults and more, fewer or other types of defaults can be used to practice the invention.

TABLE 2

Default Account
Default Exchanges and Contracts
Default Order Type
The user can set the default order type by exchange or to set the
same default for all exchanges.
Default side
Default Quantity
The user can set the default quantity by instrument or to set the
same default for all instruments.
Close after order entry
The user can determine whether or not the Order Ticket should
close by default after an order has been entered.
Quantity set to zero after order entry
The user can determine whether or not the order quantity should
return to zero once an order has been placed.
Default price for limit orders-Sell
The user can determine whether the price for sell limit orders
should default to current bid, ask, or last.
Default price for limit orders-Buy
The user can determine whether the price for buy limit orders
should default to current bid, ask, or last.
Other Settings
Always on Top
The user can set which window should stay on top by default
(if any).
This default may be overridden on a window by window basis.
Order State Timeouts
The user can set the amount of time that an order can remain in
a state of Sent, Queued, Cancel Pending or Amend Pending before
an order state timeout alert is generated.
Custom Reminders
The user can create and maintain a list of custom reminders,
which will create an audible and visual alert at the set
date and time.
The user can assign a title, date, time and description to each
reminder.
Custom reminders are saved on the local machine.
ABV Market Depth
The user can set the amount of market depth displayed on the ABV
window.
A Market Depth setting greater than the maximum depth
disseminated by the exchange will be treated as the exchange
maximum.
Hot Keys
The user can assign program shortcuts to keyboard function keys.
Fonts
The user can set a default font for all text on all windows.
The user can restore all fonts to the font selected here
(after changes have been made on individual windows).
Key Pad (for Quantity)
The user can assign the values for keypad buttons.
These values will be displayed on the key.
Order Quantity Limits (Fat Finger Rules)
The user can set the maximum quantity that may be entered for
an order.
An order exceeding this limit will not be entered.
Commissions
The user can enter commission amounts by exchange and/or by
instrument.
The commissions set here are used in the user's P & L
calculations.
Print Reports
The user can choose whether or not a window should appear upon
logoff, asking if reports should be printed.
From the window (if displayed), the user should be able to
specify which reports are printed.

### Contracts and Quotes Window

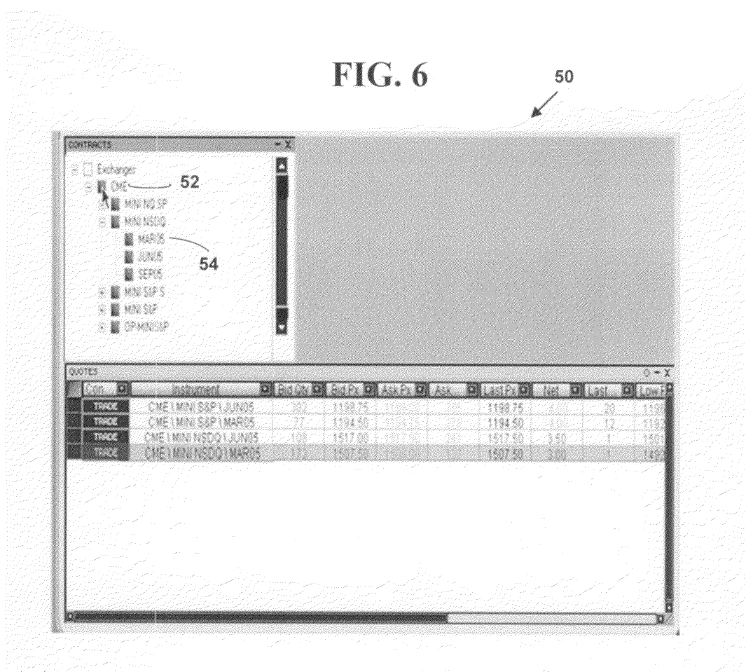

FIG. 6 is a block diagram of screen shot of an exemplary Quotes and Contracts window 50 produced by application 30 and displayed on the GUI 32. The user can select which exchange 52 (e.g., Chicago Mercantile Exchange (CME), Chicago Board of Trade (CBOT), New York Stock Exchange, etc.) and which instruments, contract and contract date combinations (e.g., Mini NSDQ March 2005) to display 54. Market data associated with a position by the unique instrument information is also displayed.

### Order and Fills Windows

The user is able to display any combination of order and fill information that they choose (although some information must be displayed in order for other information to be displayed) in Order and Fill windows respectively. The user is provided with an Orders template and a Fills template, which will each display different default data (and, therefore, provide different functionality based on user defined preferences set via the Settings window 48).

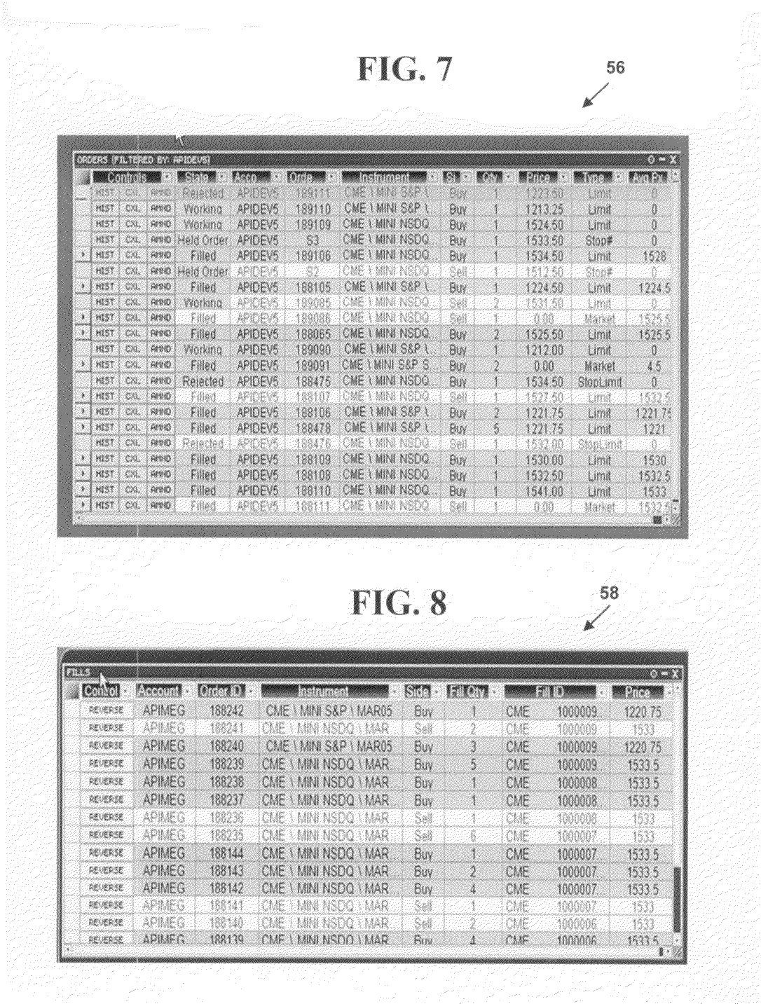

FIG. 7 is a block diagram of screen shot of an exemplary Order window 56 produced by application 30 displayed on GUI 32. Typically, an order is created by the user and submitted to an electronic trading exchange 20, 22 for possible execution. One exception to this is the Parked order. In this case, the application 30 saves the order until it is released by the user to the electronic trading exchange 20, 22.

In one embodiment, the Order window 56 displays, but is not limited to, a controls identifier, a state identifier (e.g., rejected, working, filled, held) an account identifier (e.g., APIDEV5), an order number, an instrument identifier (e.g., CME\MINI S&P), a side designation identifier (e.g., buy or sell), a quantity, a price, a type identifier (e.g., limit, pre-defined stop price, market price) an average price. However, the present invention is not limited to displaying these items and more, fewer or other items can be displayed in the Order window 56 to practice the invention.

FIG. 8 is a block diagram of screen shot of an exemplary Fills window 58 produced by application 30 displayed on GUI 32. Typically, a fill is an acknowledgment from an electronic trading exchange 20, 22 where the order was submitted that all or part of the order was executed. A special case is an external fill. An external fill is submitted manually by a system administrator.

In one embodiment, the Fills window 58 displays, but is not limited to, a control identifier, an order identifier, an instrument identifier, a side identifier, a fill quantity, a fill identifier and a fill price. However, the present invention is not limited to displaying these items and more, fewer or other items can be displayed in the Fills window 58 to practice the invention.

A new or saved Order and Fill windows 56, 58 can be launched from the Application Manager window. When the user creates and submits an order to an electronic trading exchange 20, 22, an order with a quantity greater then the maximum order limit will be rejected by the application 30. The user can create a trailing stop order against a filled order. The user is also able to create a Profit/Loss bracket around a filled order.

The user can also create a “Parked” order. A Parked order is an order that is created by the user but not submitted to an electronic trading exchange 20, 22. Parked orders are saved by the application 30 and made available to the user between application 30 launches. The user can change a working order to a parked order and visa versa. Changing a working order to a parked order, the application 30 sends a cancel to the selected electronic trading exchange 20, 22. On receipt of the cancel acknowledgement, the application 30 will change the order state to indicate that the order is parked. A parked order is also called a “Held” order.

The user can also submit a Parked order to an electronic trading exchange 30. The user can submit all parked orders at once. The user can select certain parked orders to submit (at once). The user can change the electronic trading exchange and/or contract for a parked order. If the user changes the contract, the application 30 will verify that the entered price is valid for the new contract. If the entered price is invalid for the new contract, the application 30 will prompt the user to change the price. The user can change the account for a parked order.

The user can cancel a working order. In one embodiment, a working order can be canceled with a single mouse click. In another embodiment a working order can be canceled with two mouse click, one to cancel the order and one to confirm cancellation. The user can cancel all working orders in a selected account, cancel all working buy orders in the selected account, all working sell orders in the selected account.

The user can delete a parked order. The use can delete a parked order with a single mouse click. The user can delete all parked orders in a selected account. The user can delete all parked orders in all accounts.

The user can change the following order information (for a working order) illustrated in Table 3. However, the present invention is not limited to this order information and more, fewer or other types of order information can be used to practice the invention. A user can also amend an account on an order where a n exchange supports amending an account.

TABLE 3

Prices (stop/limit/stop limit)
Quantity
The user must be able to display the detailed order history for
an order (both parked orders and those submitted to an exchange.
The order history includes orders that led to the current order if
the order was created by a cancel/replace or a parked order.

The user can also create a trailing stop order against a fill. The user can create a Profit/Loss bracket around a fill. The user can launch an Order Ticket window from a specific fill. When an Order Ticket is opened from a fill, the ticket is pre-populated with the data that corresponds to that fill (e.g., exchange, instrument, quantity, etc.)/ The side of the Order Ticket will be opposite that of the fill. Supported order types will be available to be created from the Order Ticket. Trailing stops and brackets can be linked to another order, such as a limit order. When this order is executed the Trailing Stop or bracket, etc. is then submitted to the market, or held “working” on the target device 12, 14, 16.

The Fills window 58 displays a detailed view of a fill. A fill detail includes all available fill information (including partial fills). The application 30 handles external fills. The application 30 uses separate display indicators if the fill is external (e.g., color difference, etc) on the GUI 32.

In one embodiment, Order and Fill information is displayed following standard window rules laid out by the Standard Window. The data in this Order and Fill window is displayed in the standard grid format, as described in the Standard Grid. This window will display order and fill data. The user chooses which fields should be displayed in the grid (some fields will appear by default) on the GUI 32.

Table 4 illustrates a list of order information that used in the Order and Fill windows 56, 58. Most of the information is exposed through the APIs used. However, in a few cases the information is calculated. These exceptions are indicated where they occur. However, the present invention is not limited to this order information and more, fewer or other types of order information can be used to practice the invention.

TABLE 4

Order ID
Display ID
Exchange Order ID
User Name
Trader Account
Order Type
Exchange Name
Contract Name
Contract Date
Buy or Sell
Price
Price2
Lots
Linked Order
Amount Filled
Number of Fills
Amount Open
This field is calculated by the application 30 using contract
lots minus amount filled.
Average Price
This field (the average price of all fills that make up an
order) is calculated by the application 30 because the API
does not return the correct value if there is only one lot.
Status
Date Sent
Time Sent
Date Host Received
This field will not displayed to the user, but is used for logging.
Time Host Received
This field will not be displayed to the user, but is used
for logging
Date Exchange Received
This field will not be displayed to the user, but is used
for logging.
Time Exchange Received
Date Exchange Acknowledged
Time Exchange Acknowledged
Non Execution Reason
Good-Till-Date

Table 5 illustrates a list of fill information that used in the Order and Fill windows 56, 58. Most of the information is exposed through the APIs used. However, in a few cases the information is calculated. These exceptions are indicated where they occur. However, the present invention is not limited to fill information and more, fewer or other types of fill information can be used to practice the invention.

TABLE 5
Display ID
Exchange Order ID
User Name
Trader Account
Order Type
Exchange Name
Contract Name
Contract Date
Buy or Sell
Lots
Price
Average Price
This field will need to be calculated by the application because the API
does not return the correct value if there is only one lot.
Date Filled
Time Filled
Date Host Received
This field will never be displayed to the user, but is used for logging.
Time Host Received
This field will never be displayed to the user, but is used for logging
Fill Type
Fill, External, Netted, Retained

### Positions/Market Data Window

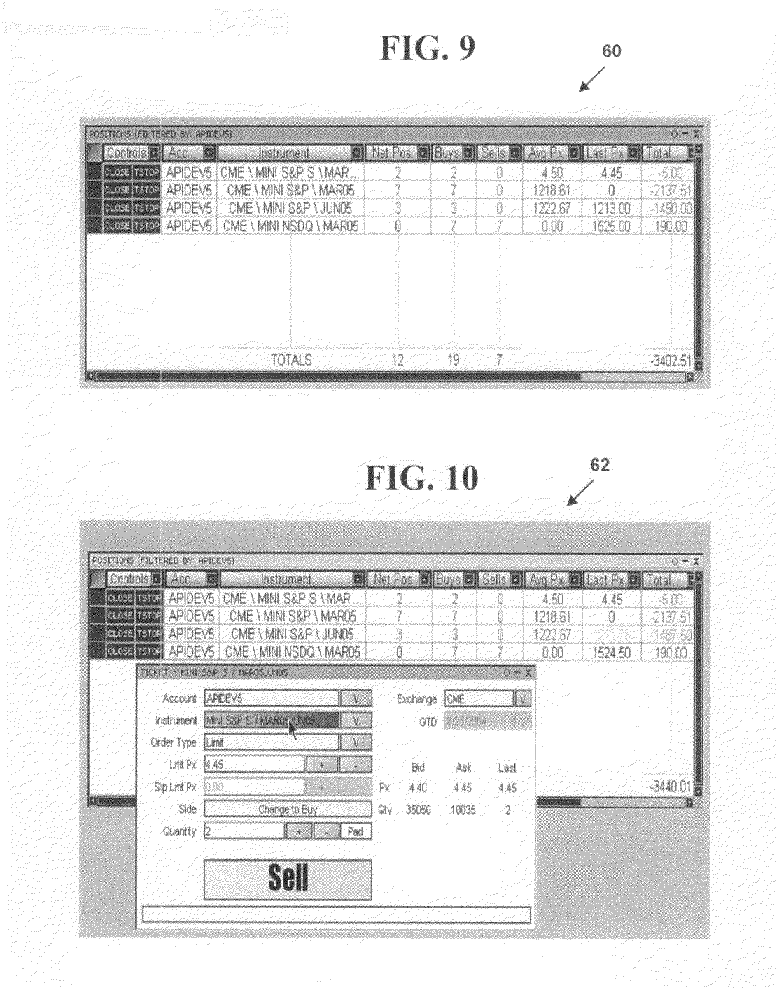

FIG. 9 is a block diagram of screen shot of an exemplary GUI 32 Position and Market Data window 60 produced by application 30 displayed on the GUI 32. The Positions and Market Data Window 60 provides representation and display of open positions and market data in the application 30. The window 60 can also be used to illustrate multiple accounts. In addition, the multiple accounts can be collapsed down to a single line summary in the window 60.

In one embodiment, the Positions and Market Data window 60 includes, but is not limited to a display of a controls identifier, an account identifier, a net position, a number of buys, a number of sells, an average price, an last price and a total. However, the present invention is not limited to displaying these items and more, fewer or other items can be displayed in the Position and Market Data window 58 to practice the invention.

The user can display any combination of order and fill information that they choose (although some information must be displayed in order for other information to be displayed). The user is provided with an Orders template and a Fills template, which will each display different default data (and, therefore, functionality).

An “open position” is a long, short, or profit or loss in an instrument or contract in an account. This open position is the aggregation of all the fills received in the instrument. Market data is delivered to the application 30 in real-time through the APIs used. A new or saved Positions/Market window 60 can be launched from the Application Manager window. The user can launch an Order Ticket window 84 from a specific position.

FIG. 10 is a block diagram of screen shot of an exemplary Position and Market Data window for an Order Ticket from a sell position 62 produced by application 30 and displayed on the GUI 32. When a ticket is opened from a position, an Order Ticket window 84 is pre-populated with the data that corresponds to that position (e.g., exchange, instrument, quantity, etc.). For example in FIG. 10, an Order Ticket window includes data (e.g., APIDEV5, CME\MINI S&P, Limit, Limit Px 4.45, Quantity 2, etc.). The side of the Order Ticket will be opposite that of the position. The user can launch a window that will allow them to create a Profit/Loss (P/L) Bracket around an open position. The order sides default to opposite of the position. The order quantities default to the position quantity. The user can also launch a window that will allow them to create a Stop or Stop Limit order against an open position.

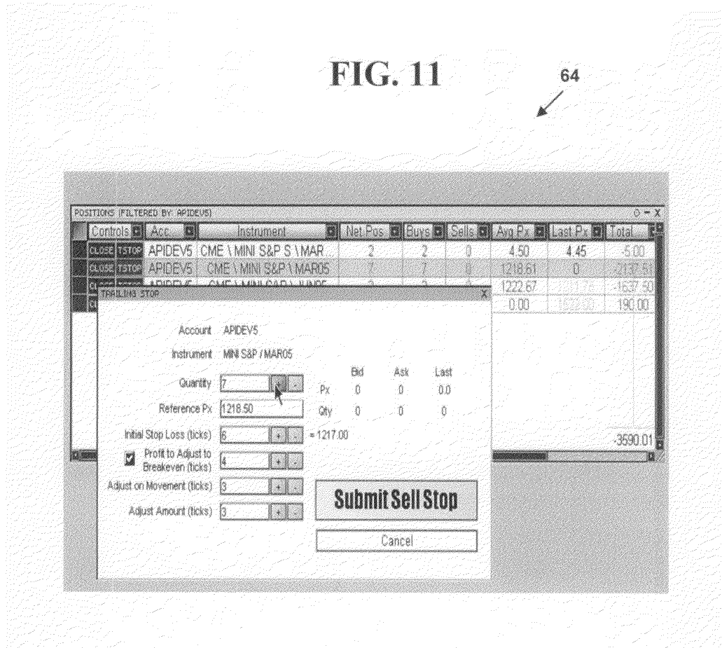

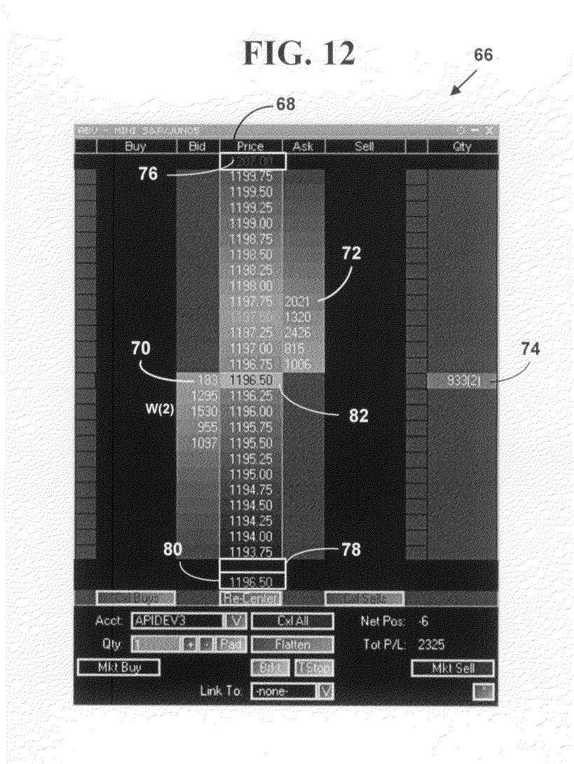

FIG. 11 is a block diagram of screen shot of an exemplary Position and Market Data window for a sell stop order 64 produced by application 30 displayed on the GUI 32. The order side defaults to opposite of the position. The order quantity defaults to the position quantity. The user can also launch a window that will allow them to create a Limit order against an open position. The order side defaults to opposite of the position. The order quantity defaults to the position quantity.

The user can display all of the fills that comprise a position. The user can flatten the open position in the instrument for the selected account. The window 60 includes a Flatten button for flattening a net position. When the user chooses to flatten, working orders for the instrument are canceled and an order is entered that flattens the net position (i.e., the quantity of the order will be equal to the net position and the order will be placed on the opposite side of the net position). The flattening is achieved with a single order (i.e., the user cannot enter more than one order to flatten).

Position information and Market Data is displayed following standard window rules laid out in the Standard Window. The data in this window 60 is displayed in the standard grid format, as described in the Standard Grid.

Table 6 illustrates a list of position information that is available from this window 60. However, the present invention is not limited to this position information and more, fewer or other types of position information can be used to practice the invention.

TABLE 6

Account
Exchange Name
Contract Name
Contract Date
Net Position
Avg. Price
Open P & L
Cumulative P & L
Total P & L
Commission

The GUI 32 will also show market data and position information. The user chooses which fields should be displayed in the grid (i.e., some market data fields will appear by default). Table 7 is a list of market data that is available from this window 60. However, the present invention is not limited to this market data more, fewer or other types of market data can be used to practice the invention.

TABLE 7

Exchange Name
Contract Name
Contract Date
Bid Price
Bid Size
Ask Price
Ask Size
Last Traded Volume
Net Price Change
Last Traded Price
High Price
Low Price
Opening Price
Closing Price
Total Traded Volume
Contract Status
This is the status of the contract on the exchange
(i.e. open, pre-open, trading, etc.)

### Aggregated Book View (ABV) Window

The ABV Window allows the user to view bid size and offer size by price for a particular instrument in a market depth-type format. The window displays working orders for a selected account in a single instrument. The data on this window is displayed and updated in real-time. The window also allows the user to enter various order types. In one embodiment, two ABV widows are displayed by default. In another embodiment, one or more than two ABV windows are displayed by default.

FIG. 12 is a block diagram of screen shot of an exemplary ABV window 66 produced by application 30 displayed on GUI 32. The ABV window 66 includes a dynamically displayed Price column 68.

In one embodiment, the ABV window displays a buy column, a bid column, a dynamic price column, an ask column, a sell column, a quantity column, a re-center button, a cancel buy button, a cancel sell button, a cancel all button, a market buy button, a flatten button, a bracket button, a TStop button, a net position and a total P/L. However, the present invention is not limited to displaying these items and more, fewer or other items can be displayed in the ABV window 66 to practice the invention.

The user can select an instrument or contract to view in an ABV window 66, and can change the instrument or contract from this window 66. Changing the instrument or contract changes the data displayed to that of the selected instrument or contract. The user can select an account from available accounts. The window 66 displays the total quantity of orders working in the market at each price. Both buy and sell quantities are displayed. Quantities are updated as the instrument order book changes. The window 66 displays an indicator depicting the all of the user's open orders, for the selected account, at each price. The window 66 indicates a state of each order. Open order states include, but are not limited to: Queued, Sent, Working, Part Filled, Cancel Pending and Amend Pending, Held, Cancelled, Filled.

This window 66 indicates the order type for each order. The window 66 indicates the working quantity of each order. The window 66 displays parked orders for the selected instrument. The window 66 displays the user's net position in the selected instrument for the selected account. The window 66 displays the trade quantities for each corresponding price level. The user can select to view the total quantity currently trading at a price. This quantity is increased as each trade at a price occurs. The cumulative quantity remains in the window 66 until the price changes (at which time the cumulative trade quantity for the new price will be shown).

The user selects to view the last quantity currently trading at a price. This view shows the individual trade quantities. Only quantities for the current price are shown. The window 66 displays the total traded volume for the instrument. The window 66 displays all of the aforementioned data at once.

The user sets and adjusts the specified quantity for orders entered via this window 66. The quantity is set via a spinner, text entry or keypad entry. Each key-pad input increases a specified quantity by an amount displayed on the key (key value). The user selects to have the specified quantity set to zero after order entry. The user resets the quantity to zero (i.e., without entering an order). A right click on the mouse increases the quantity, left click decreases the quantity.

Orders entered via this window 66 will have a quantity equal to the quantity specified at time of entry. The default account for any orders entered from the ABV window 66 is the selected account. The can enter a limit order by clicking a cell in the bid quantity or offer quantity columns. Limit orders are default order type.

Order side will be set to BUY if the user clicks in the bid quantity column 70. Order side will be set to SELL if the user clicks in the offer quantity column 72. Orders will have a quantity equal to the specified quantity. Order limit price must equal the price corresponding to the clicked offer/bid quantity.

The user enters a stop order by clicking a cell in the bid or offer quantity columns 70, 72. Order side will be set to BUY if the user clicks in the bid quantity column 70. Order side will be set to SELL if the user clicks in the offer quantity column 72. Orders must have a quantity equal to the specified quantity. The order stop price will equal the price corresponding to the clicked offer/bid quantity. The order is entered for the selected account. The user is able to enter a buy stop below the market or a sell stop above the market. If the user does this, a window appears, warning the user that the buy or sell will be immediately executed.

The user can enter an OCO (One Cancels Other) pair of orders. The user can also enter a profit/loss bracket. The user can enter a trailing stop. The user can also enter an “If-Then Strategy.”

The user can change the limit price of a working limit order by dragging the working order indicator to a new price. The user can change the stop price of a working stop order by dragging the working order indicator to a new price. This will cause a cancel replace to be entered at the electronic trading exchange 20, 22. The user can change the quantity of a working order by right clicking in the cell displaying the working order. A right click on a mouse displays a context menu listing order quantities centered on the current quantity. The user can also adjust account number. In another embodiment, to amend a price of an order not listed in a window such as the ABV window 66, a user right-clicks and drags the cells associated with the order back to the ABV window 66.

The user can cancel a working order with a single mouse click. The user can cancel all open orders in the instrument for the selected account. The can cancel all open buy orders in the instrument for the selected account. The user can cancel all open sell orders in the instrument for the selected account.

Users can have orders at a price displayed as a concatenated total, or displayed as each individual order. When the display of individual orders is to large for the display, individual orders will be displayed starting with the first order entered and then the remaining orders that do not fit in the display will be concatenated. Concatenated orders are indicated as such using a symbol that is attached to the total. Users can also adjust the display of the ABV by adding or removing columns, buttons and functions.

The user uses the open position in the instrument for the selected account. This window 66 includes a Flatten button for flattening the net position. When the user chooses to flatten, all working orders for the instrument are canceled and an order is entered that flattens the net position (i.e., the quantity of the order will be equal to the net position and the order will be placed on the opposite side of the net position). The flattening is achieved with a single order (i.e., the user cannot enter more than one order to flatten).

The user can center the dynamic Price column 68 on the current market. The user can scroll the dynamic Price column 68 to display prices above or below the current market. All data is displayed real-time.

This ABV window 66 follows the standard window rules laid out in the Standard Window. The data in this window is displayed in a grid, but this grid will not follow all of the standard grid rules.

The user can choose from a list of columns to display. Certain columns will be displayed by default. Certain columns will not be removable (price for example). The user can change the order of the displayed columns by dragging a column heading to a new position. The user can manually resize a column. The user can resize all columns to fit the screen. The user can resize all columns to fit the contents. The user can resize a selected column to fit the contents. Double clicking on the column heading border sizes a column so that data only is displayed with no redundant space.

The user can change the font for all columns in the grid. The user can change the font for an individual column. The user can change the foreground color of a column. The user can change the background color of a column. The user can restore the default grid settings.

The ABV window 66 is resizable. When it is resized, the columns expand and contract so that all data is still shown. However, after resizing the window, the user can resize the columns to get rid of wasted space and then change the font size (i.e., so it's more readable when the screen is small).

This ABV window 66 will display the following fields illustrated in Table 8 in a ladder format. However, the present invention is not limited there fields and more, fewer or other types of fields can be used to practice the invention.

TABLE 8
Price
Centered on the current market prices when launched.
Market Bid Quantity
Market Offer Quantity
Trade Quantity as determined in section 11.3 above
Open Buy Orders indicating status, type and quantity for each order
Open Sell Orders indicating status, type and quantity for each order
Parked Orders

The ABV window 66 displays real-time data for a particular contract, allowing a user to get a current snapshot of the market. Thus, the ABV window 66 can also be considered an “Ask, Bid, Volume” window.

An instrument or contract can be added to an open ABV window 66 in the same way that a contract was added to the Quotes window 50. Simply select the contract that to display and then drag it into the ABV window 66. Contracts can be dragged from any of the windows displayed on the screen.

Once a contract has been added to the ABV window, the data illustrated in Table 9 is displayed on the ABV window.

TABLE 9
A current number of Bids 70 and Asks 72 on an electronic trading
exchange 20, 22 for particular price levels.
A total quantity currently trading at a certain price.
A number in parentheses 74 next to the total quantity is the last
quantity traded at that price.
A price in red is the daily high 76. A price shown in blue is the
daily low 78. A last traded price is shown in gray 80.
The last traded price 82 is also highlighted on a dynamic price
column 68. When there has been an uptick in this price, this cell
will be green. When there has been a downtick, this cell will be red.
If there has been no change, this cell will appear yellow.
The Buy and Sell columns display a total number of open orders at
each particular price. For example, a “W2” in the Buy column
indicates that there are working orders with a total quantity of
two at the specified price.
Net Position and Total P/L on the ABV can be monitored by simply
referring to the lower right hand corner of the window.

On the ABV window 66, the price of any open Buy or Sell orders can be amended. To change the price of an order, a row selector that corresponds with the order to amend is selected buy left-clicking and holding down a left mouse button, dragging a cursor connected to the mouse up or down to a desired new price and releasing the mouse button. A white cursor arrow appears to indicate a change in price. The price amended will be submitted as soon as the mouse is released. If there multiple orders at the same price (and on the same side), all of the orders will be amended to the new price when dragging the concatenated order. The user can cancel a signal order at a price where multiple orders exist. They can also modify a single order at a price where multiple orders exist. They do this by selecting the individual order and dragging and dropping.

Another feature of the ABV window 66 is that a desired position on the dynamically displayed Price column 68 can be moved. If it is desired to scroll up or down on a market price on the dynamically displayed Price column 68, the dynamically displayed Price column 66 is hovered over with a mouse. A yellow cursor arrow will appear, pointing up if the mouse cursor is in the top half of the dynamic price column 68, or down, if the mouse cursor is in the bottom half of the dynamic Price column 68. Clicking on the cursor arrow will scroll the grid in the direction that the arrow points. In another embodiment, the yellow cursor arrow does not appear.

The ABV window 66 provides a dynamic Price column 68 centered upon the lasted traded price that continuously changes with fluctuations in the last traded price. To enter an order, a mouse cursor is hovered anywhere in the ABV window 66. This mouse hover puts a user in the “order entry mode.” In the order entry mode a trade near last traded price can be entered or prices on the dynamic price column can be manually adjusted away from the last traded price. To scroll up or down the market prices on the dynamic Price column 68 to enter a trade, the mouse cursor is hovered over the dynamic Price column 68. A large yellow arrow will appear, pointing up if the mouse curser is in the top half of the dynamic price column, or down, the mouse cursor is in the bottom half of the dynamic price column. Clicking on the large yellow arrow will scroll the prices in the dynamic price column in the direction that the large arrow points so a trade can be entered away from a current market price.

If the dynamic Price column 68 is scrolled up or down and the last traded price is not centered on your ABV, the dynamic price column will start to scroll until the last traded price is again centered in the ABV window 66. In addition, if there is no further activity from a mouse for a period of time the dynamic Price column 68 will also start to scroll. As a visual indication, just before the dynamic price column begins to scroll, the mouse cursor will turn yellow and start to flash. This is a warning that the ABV window is about to begin re-centering around the last traded price. If, at any time, the mouse cursor is moved out of the ABV window, you leave the order entry mode and the ABV will automatically re-center the dynamic price column on the last traded price the next time the market price changes.

Stop and limit orders can also be entered on the ABV window 66 with just a click of a mouse. Before entering limit or stop orders an account is chosen and a quantity is entered. If a user has access to multiple accounts, the user can select the desired account by using the Account drop down menu. The user can input a number of lots to trade by typing the number in, by using the + or − buttons, or by using a keypad. A default quantity can be set via the Settings window. After selecting an account and quantity, limit and stop orders can be placed.

To enter a Buy Limit order, the mouse is clicked in the Bid column next to the Price to enter the order for. A limit order to buy will be entered at that price for the quantity specified, and a new working order will be reflected in the Buy column. Likewise, to enter a Sell Limit order, the mouse is clicked in the Ask column next to the Price to enter the order for.

To enter a Buy Stop order, the mouse is right-clicked in the Bid column next to the Price to enter the order for. A stop order to buy will be entered at that price for the quantity specified, and a new order will be reflected in the Buy column. Similarly, to enter a Sell Stop order, the mouse is right-clicked in the Ask column next to the Price that you want to enter the order for.

In addition to Limit and Stop orders, Market orders can be executed on the ABV window 66 using the Market Buy and Market Sell buttons. The ABV window can also be set up so that a Bracket or Trailing Stop order will automatically be created any time an order entered via the ABV is filled. The Bracket and Trailing Stop parameters will default to the values set up on the Settings window. To link a Bracket or Trailing Stop order to all orders entered via the ABV, choose Bracket or TStop from the Link To drop down box. A small window pops up with the default parameters for a bracket. The bracket levels can be changed by typing in a desired number, or using the “+” and “−” buttons. A limit order will be the profit order type, and for a loss order type, either choose a stop or a trailing stop can be selected.

For example, if a stop order is chosen, as soon as the order was filled, two new orders were entered. A limit order was created at a price that is five ticks above the market order's price and a stop order was created at a price that is three ticks below the market order's price Both orders have the same quantity that the market order had. Because these orders were entered as part of a bracket, when one of these orders is filled, the other will automatically be cancelled. Likewise, TStop is chosen from the Link To drop down box, a small window will appear that allows you to view and change trailing stop parameters. Like the bracket, a trailing stop will be entered once an order entered via the ABV window 66 is filled.

The ABV also allows cancellation of some or all of working orders as well. To cancel a particular order, the mouse cursor is placed over that order in the Buy or Sell column, whichever applies, and a yellow X appears over the working order. A mouse click on the yellow X will cancel that particular order. If multiple orders are entered at the same price (and on the same side), they will all be cancelled.

### Order Ticket Window

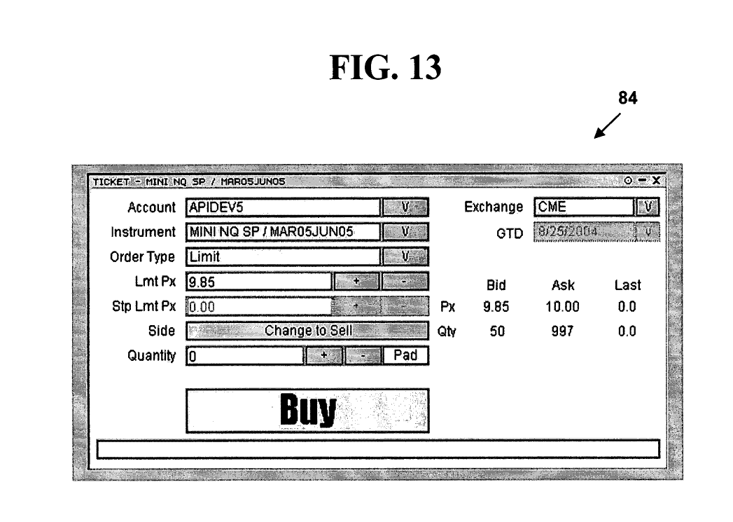

FIG. 13 is a block diagram of screen shot of an exemplary Order Ticket window 84 produced by application 30 and displayed on GUI 32. This window 84 allows the user to create and enter all types of orders supported by the application and the APIs used. This window 84 is accessible via all windows except for Login, Settings, Client Messaging and Reports windows. Multiple order tickets can be launched and multiple windows 84 will be created. The Order Ticket window 84 is a member of a Desktop Layout. Order types, including Synthetic order types can be entered from this window.

In one embodiment, the Order Ticket window 84 displays, but is not limited to, an account identifier, an instrument or contract identifier, an order type, a limit price, if any, a stop limit price if any, a side identifier, a quantity identifier, an exchange identifier a current bid, ask, and last traded price, a current bid, ask or last traded quantity and a buy or sell identifier. However, the present invention is not limited to displaying these items and more, fewer or other items can be displayed in the Order Ticket window 84 to practice the invention.

If necessary, the Order Ticket window 84 will change or launch supporting windows to accommodate more complex order types. In one embodiment, the Order Ticket window 84 displays, but is not limited to, an account identifier, an instrument or contract identifier, an order type, a limit price, if any, a stop limit price if any, a side identifier, a quantity identifier, an exchange identifier a current bid, ask, and last traded price, a current bid, ask or last traded quantity and a buy or sell graphical button. However, the present invention is not limited to this embodiment and other embodiments can be used to practice the invention.

The user can select the account that the order applies to. The user can change the side of the order. The ticket background color depends upon the side chosen. For example, the background is set to blue for buy orders and set to red for sell orders. The following market data is displayed, but is not limited to, on this window 84 for the selected instrument: bid price, bid size, ask price, ask size, and last traded price.

This window 84 also does follow the standard window rules laid out in the Standard Window. The window can also be resized. The user can select to have the order ticket always on top. The default for this functionality is determined in the Settings Window. The Order Ticket window 84 is member of a Desktop Layout window. The Order Ticket window 84 settings are saved when it is a member of a Desktop Layout.

This window 84 is comprised of all the fields necessary to enter an order. The field defaults are set in the Settings window 48, but this window 84 may display different defaults depending on where it was launched from (for example, if it was launched from a specific fill or position).

Table 10 illustrate a list of the fields that are used to create a standard order. Synthetic orders also created directly from this window 84. In another embodiment, a separate window may be launched, or there may be some other method of accessing synthetic order entry. However, the present invention is not limited to this order information and more, fewer or other types of order information can be used to practice the invention.

TABLE 10
Exchange
The default value for this field is determined from the
window where it was launched or in Settings.
Instrument
This field is filtered to display valid instruments
based on the exchange that is selected.
Contract Date
This field is filtered to display valid contract dates
based on the instrument that is selected.
Order Type
This field is filtered to display valid order types based
on the exchange that is selected.
Limit Price
This field defaults to either the current bid, ask or last
as determined by Settings and by the side.
This price does not change once the order is open.
This field is enabled only for stop, stop limit, MIT
orders and the synthetic equivalents for those order types.
The use is able to enter the price via keyboard entry
or spinner,
Order Quantity
The user is able to change the specified order quantity
through a key-pad control.
Each key-pad input increases the specified quantity by the amount
displayed on the key (the key value).
The user has ability to set the quantity back to zero.
The user is able to select to have the specified quantity set to
zero after order entry.
Secondary Price
This field is enabled only for stop limit orders.
Good-Till-Date
This field is enabled only for orders with TIF (Time in Force) of GTD.
This field defaults to the current trade date.

### Reports Window

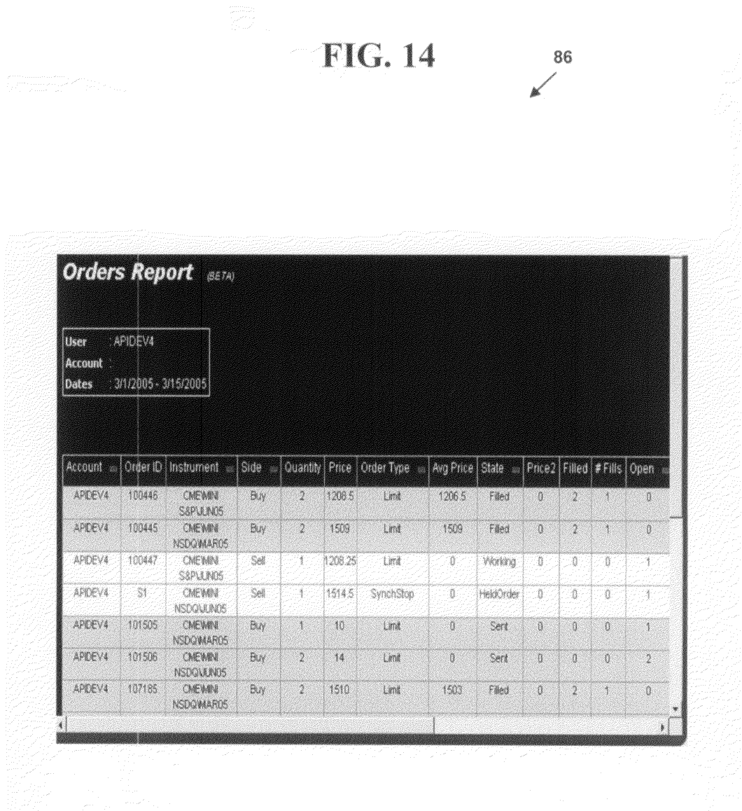

FIG. 14 is a block diagram of screen shot of an exemplary Reports window 86 produced by application 30 displayed by GUI 32. The Reports window 86 allows the user to create and enter all types of orders supported by the application 30 and APIs used. This window is accessible via all windows except for Login, Settings, Client Messaging and Reports. Multiple order tickets can be launched. The order ticket can be a member of a Desktop Layout window. In another embodiment, the Reports window 86 is not displayed by application 30. Instead a network application (e.g., a web application) is used with a back office system to see reports on trading activity.

In one embodiment, the Reports window 86 displays, but is not limited to, an account identifier, an order identifier, an instrument identifier, a side identifier, a quantity, a price, an order type, an average price, a state, a price2, file, number of fills and an open column. However, the present invention is not limited to displaying these items and more, fewer or other items can be displayed in the Reports window 68 to practice the invention.

Order types, including synthetic order types are summarized from this window 86. If necessary, the Order Ticket window 84 changes or launches supporting windows to accommodate more complex order types. The user can select the account that the order applies to. The user changes the side of the order. Ticket background color depends upon the side chosen. For example, the background is blue for buy orders ant he background is red for sell orders.

Table 11 illustrates a list of the fields used to create a standard order report. However, the present invention is not limited to this order information more, fewer or other types of order information can be used to practice the invention.

TABLE 11
Exchange
The default value for this field is determined from the window
where it was launched or in Settings.
Instrument
This field is filtered to display valid instruments based on the
exchange that is selected.
Contract Date
This field is filtered to display valid contract dates based on
the instrument that is selected.
Order Type
This field is filtered to display valid order types based on the
exchange that is selected.
Limit Price
This field defaults to either the current bid, ask or last as
determined by Settings and by the side.
This price does not change once the order is open.
This field is enabled only for stop, stop limit, MIT orders and
the synthetic equivalents for those order types.
The user is able to enter the price via keyboard entry or spinner.
Order Quantity
The user is able to change the specified order quantity through a
key-pad control.
Each key-pad input increases the specified quantity by the amount
displayed on the key (the key value).
The user has ability to set the quantity back to zero.
The user is able to select to have the specified quantity set to
zero after order entry.
Secondary Price
This field is enabled only for stop limit orders.
Good-Till-Date
This field is enabled only for orders with TIF (Time in Force) of GTD.
This field defaults to the current trade date.
This window allows the user to view and print reports.
Screen Access
This window is accessed via the Manager window. Multiple report
windows cannot be launched. The report window is not a member of any
Desktop Layout.
Functional Requirements
No trading functionality is available from this window.
Fill Report
The user is able to view and print a fill report by account for the
current day.
The data for this report is saved on the client.
Order History Report
The user is able to view and print an order history report for the
current day or for any range of time up to 30 days.
History includes parked orders.
The data for this report should is on the client machine 30.
Orders Entered Report
The user is able to view a report showing orders entered that were
filled for the current day or for any range of time up to 30 days.
The data for this report is saved on the client.

### Client Logs

This functionality allows the user to send error and audit logs. A log of application errors is maintained. Application error logs, created daily, are retained for ten trading days. The user does not have ability to view the application error log. Logs are stored on the client and are not be encrypted, but should not be easily accessible to the user. The user can send the application error log to another location from within the application 30.

An audit log is created. The audit log contains detailed order history, including all available times associated with the order. The log also contains fills associated with the order. The log contains messages pertaining to the application which indicate connection activities and statuses. Audit logs, created daily, are retained for ten trading days. The user does not have ability to view the audit log. Logs are stored on the application 30 and should not be encrypted, but should not be easily accessible to the user. The user can send the audit log to another location from within the network 18.

### Specialized Order Functionality

The application 30 also provides specialized order functionality. This functionality is available to the user wherever orders can be entered. The user creates one-cancels-other (OCO) order pairs. An OCO order is one that allows the user to have two working orders in the market at once With the execution of one order the other is canceled. The user can construct an OCO pair across different instruments traded on a single electronic exchange. The user can construct an OCO pair across different instruments on two electronic trading exchanges. The user can construct an OCO pair combining orders of any order type that is supported by the exchange (or supported synthetic order types).

The user cancels OCO orders before exiting the application 30. If the user has any open OCO's upon logoff, the GUI 32 warns the user that the orders will be cancelled and allow the user to cancel the logoff if desired. By default, entering a quantity for the OCO enters that same quantity for both sides of the OCO.

A complete fill of one order cancels the other order. If there is a partial fill on one leg of the OCO, the other side of the OCO is reduced by the amount that was filled. This functionality will only occur if both legs of the OCO are entered with the same quantity. The user has the ability to turn off this functionality, so that the order quantities don't automatically decrement and the orders are canceled only when one order is completely filled. If the user enters different quantities, this functionality are automatically turned off and disabled.

The user can cancel individual orders of the pair, leaving the remaining order in the market. The user can cancel both orders in the pair simultaneously. The user can change the price for an individual order of the pair. The user can create a profit/loss bracket order pair. A Profit/Loss bracket is a specific case of an OCO order pair. This order pair consists of a limit order to establish a profit and a stop loss order to limit loss. The stop loss portion of the bracket should be able to be a “trailing stop.” The use is able to create a profit/loss bracket around an existing position. The user is able to create a profit/loss bracket around a fill. The use can create a profit/loss bracket around an order in the filled state.

The user can create trailing stop orders. A trailing stop is an order that tracks a price of the instrument and adjusts the stop trigger price in accordance with a predefined rule (i.e., stop trigger is changed when the market changes a certain number of ticks).

Trailing stop orders can be either of type stop or stop limit. For stop limit orders, the limit price will be changed such that it keeps the same differential from the stop trigger price. In order to set up the trailing stop rule, the user must enter: the number of ticks that the market must change before the stop trigger price should be adjusted. The number of ticks that the stop trigger price should be adjusted when an adjustment is warranted. A trailing stop order is purely synthetic.

The stop order should only be known to the client until it is actually triggered. At that time either a market order (in the case of an order type of stop) or a limit order (in the case of a stop limit order) will be entered into the market. A trailing stop only adjusts the stop trigger price in the profitable direction of the trade. A trailing stop order to sell does not adjust the stop trigger price to a value less than the initial trigger value. A trailing stop order to sell only increases the stop trigger price. A trailing stop order to sell only adjusts the stop trigger price when new high prices are traded in the instrument. This will prevent adjusting the stop trigger price if the instrument price retraces a profitable move but does not trigger the stop.

A trailing stop order to buy does not adjust the trigger price to a value greater than the initial trigger value. A trailing stop order to buy only decreases the stop price. A trailing stop order to buy must adjusts the trigger price when new low prices are traded in the instrument. This will prevent adjusting the stop trigger price if the instrument price retraces a profitable move but does not trigger the stop. Trailing stops are only valid while the user is logged into the application 30. Application 30 exit will have the effect of the trailing stop not being in the market. On application exit, if the user has trailing stops entered, the user will be warned that the stop will not be worked while the application is closed.

The user is to choose to save trailing stops. On application 30 launch, the user is advised of any saved trailing stops and given the opportunity to reenter them.

The user is able to create parked orders. A parked order is an order that is created by the user but not submitted to the market. The user is able to release a parked order. Releasing a parked order submits it to the market. The user can change a working order to a parked order. This sends a cancel to the exchange. On receipt of the cancel acknowledgement, the application 30 changes the order state to indicate that the order is parked. Parked orders are saved on application exit. Parked orders are restored on application 30 launch.

### If-Then Strategies

The user can create an “If-Then Strategy.” With an If Then Strategy, an order is entered into the market. Upon receipt of a fill acknowledgement for the order, one or more other orders are automatically entered by the application 30 based on the If-Then strategy. Typically, the orders that are entered with If-Then Strategy will be orders to manage profit and loss expectations for the fill that was received on the original order. The user can create an If-Then strategy where on the receipt of the acknowledgement of an order fill, a profit/loss bracket is entered around the fill price for the filled quantity. The user can create an If-Then strategy where on the receipt of the acknowledgement of an order fill, a stop or stop limit order is entered at an offset from the fill price for the quantity of the fill. The user can create an If-Then strategy where on the receipt of the acknowledgement of an order fill, a trailing stop order is entered at an offset from the fill price for the quantity of the fill. The user can create an If-Then strategy where on the receipt of the acknowledgement of an order fill, a limit order is entered at an offset from the fill price for the quantity of the fill. The user can create an If-Then strategy where on the receipt of the acknowledgement of an order fill, an OCO order pair is entered.

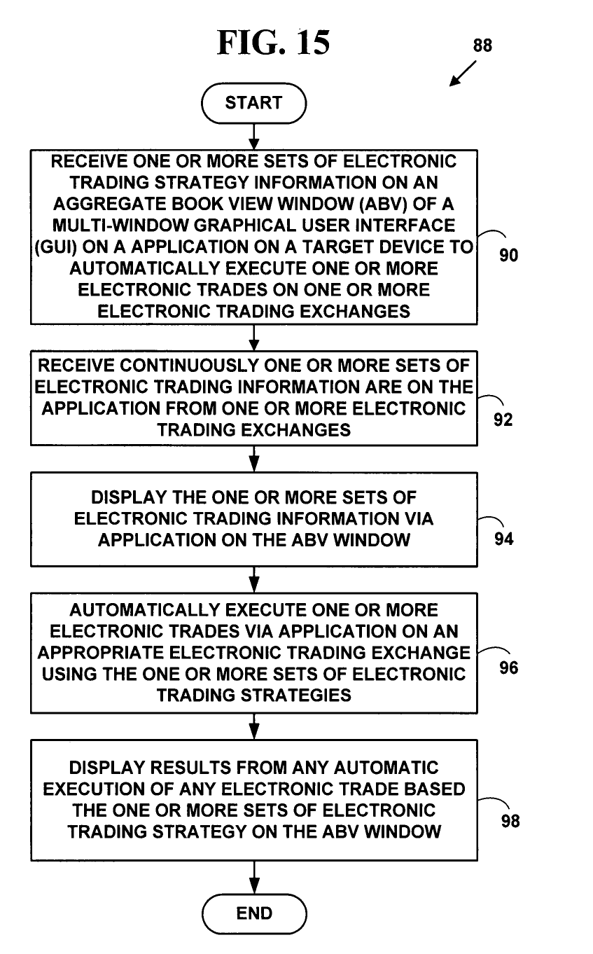

FIG. 15 is a flow diagram illustrating a Method 88 for electronic trading. At Step 90, one or more sets of If-Then electronic trading strategy information is obtained on an aggregate book view window 66 on a application 30 on a target device to automatically execute one or more electronic trades on one or more electronic trading exchanges. At Step 92, one or more sets of electronic trading information are continuously received on the application 30 from one or more electronic trading exchanges 20, 22. At Step 94, the one or more sets of electronic trading information are displayed via application 30 on the ABV window 66. At Step 96, one or more electronic trades are automatically electronically executed via application 30 on an appropriate electronic trading exchange 20, 22 using the one or more sets of If-Then electronic trading strategies. At Step 98, results from any automatic execution of any electronic trade are formatted and displayed on the ABV window.

In one embodiment, the application 30 comprises a Multi-Execution Trading Platform that allows a trader to setup a strategy to trade two or more distinct markets (e.g., cash and futures) which have a predefined relationship (e.g., one-to-one) and automatically execute both markets simultaneously. In one embodiment, the Multi-Execution Trading Platform includes a configurable slippage factor that is predefined by the trader and allows the trader to safely execute a 2^{nd} leg, 3^{rd} leg, of the trade if the initial trade for the futures misses. In another embodiment, the Multi-Execution Trading system includes a one-to-one trade from either the cash side or the futures side first. In another embodiment, the Multi-Execution Trading system includes a best cash market to trade from.

The Multi-Execution Trading System also includes Duration functionality allows traders to enter in one-to-one strategies which are not in a one Cash to ten futures ratio. It also allows traders to enter in one-to-one ratios such as one Cash and twelve futures etc.

In another embodiment, the Multi-Execution Trading System also includes a graphical Profit and Loss (P&L) blotter provides risk monitoring at a firm, group, or trader level. The Multi-Execution Trading System calculates P&L on a real-time basis with Mark to Market functionality. The Multi-Execution Trading system includes firm wide status messages that can be broadcast to all traders who are viewing a graphical blotter and it will illustrate actual P&L and not just intraday by including previous days total equity position.

The Multi-Execution Trading System also allows traders to receive futures and cash market data real-time into a spreadsheet (e.g., Excel, etc.) and allows traders to receive both cash and futures trades real-time into a spreadsheet.

The Multi-Execution Trading System also provides an electronic “black box” that allows a trader to enter a desired trading formula into the application 30, thereby allowing the application 30 to automatically execute electronic trades via one or more electronic trading exchanges. The black box allows automatic tracking and execution of both actual and synthetic trading entities.

### Processing Electronic Trading Information

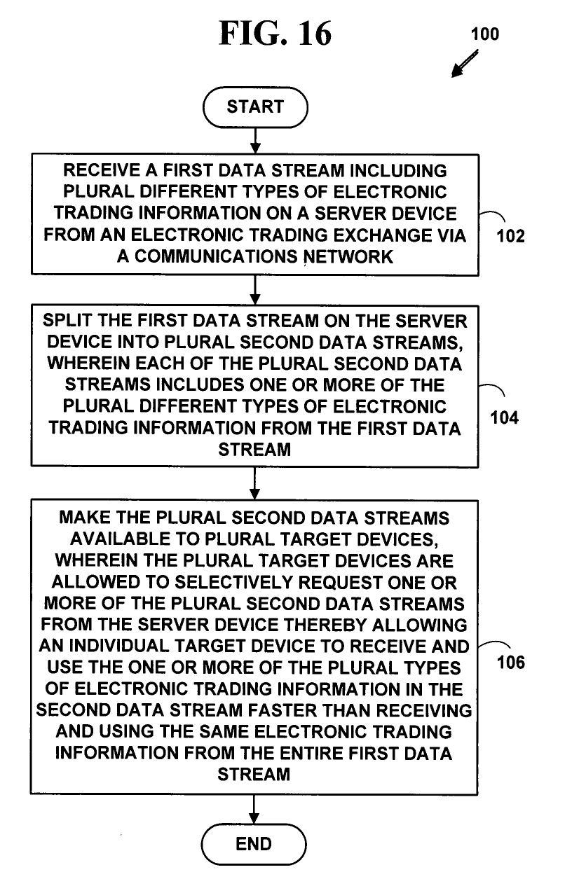

FIG. 16 is a flow diagram illustrating a Method 100 for processing electronic trading information. At Step 102, a first data stream is received on a server device 24 including plural different types of electronic trading information from an electronic trading exchange 20, 22 via a communications network 18. At Step 104, the first data stream on the server device is split into a plural second data streams. Each of the plural second data streams includes one or more of the plural types of electronic trading information from the first data stream. At Step 106, the plural target devices 12, 14, 16 are allowed to selectively request one or more of the plural second data streams from the server device thereby allowing an individual target device 12, 14, 16 to receive and use the one or more of the plural types of electronic trading information in the second data stream faster than receiving and using the same electronic trading information from the first data stream.

Method 100 is illustrated with an exemplary embodiment. However, the invention is not limited to this embodiment and other embodiments can also be used to practice the invention.

In such an exemplary embodiment at Step 102, a first data stream 31, 33 including plural types of electronic information related to electronic trading is received on a server device 24 from one or more electronic trading exchanges 20, 22 via a communications network 18. In one embodiment of the invention the first data stream includes, but is not limited to, electronic trading information from an electronic trading exchange (e.g., New York Stock Exchange, Chicago Board of Trade, London Stock Exchange, etc.).

The first data stream 31, 33 includes plural types of electronic information including, but not limited to, current market data, posting and canceling of order information, order fill and status information, commentary by market analysts, current market news and other types of information relevant to electronic trading sent from the electronic trading exchange. This first data stream 31, 33 is provided in many different formats. One format includes a data stream with one portion of information for each data category included in the first data stream in each data packet sent across the communications network 18. Another format includes interleaving data packets in the data stream wherein each data packet includes only one type of electronic trading information.

For example, a first data packet in the data stream may include only current price information for a specific financial instrument. A second data packet in the data stream may include only order fill and status information, etc. These and other formats may be used by the trading exchanges 20, 22 to send out data streams. The server device 24 accepts these and other data stream formats and splits the information contained therein into the plural second data streams.

At Step 104, the first data stream 31, 33 on the server device 24 is split into a plural second data streams 35. Each of the plural second data streams 35 includes one or more of the plural types of electronic trading information from the first data stream. For example, the first data stream including current market data, posting and canceling of order information, order fill and status information is split into plural separate data streams with one of the plural second data streams including only current market data, another one of the plural second data streams including only posting and canceling of order information, yet another one of the plural second data streams including only order fill and status information, etc.

At Step 106, the plural target devices 12, 14, 16 are allowed to selectively request one or more of the plural second data streams from the server device 24 thereby allowing an individual target device 12, 14, 16 to receive and use the one or more of the plural types of electronic trading information in the second data stream faster than receiving and using the same electronic trading information from the first data stream. For example, a target device 12 may request one of the plural data streams relating only to current market data, while another target device 14 may request two plural data streams relating to posting and canceling of order information and order fill and status information, etc. Since a target device 12, 14, 16 can select only the individual data streams from plural second data streams that are desired, the target device 12, 14, 16 is able to receive and use the selected data streams instead of receiving and processing the first data stream including all of the plural types of electronic trading information.

In one embodiment, the one server device 24 is specifically configured for and optimized for receiving the first data stream, for splitting the first data stream into the plurality of second data streams and receiving requests from the plurality of target devices 12, 14, 16 and selectively sending the requested information to the plurality of target devices 12, 14, 16.

In other embodiments, plural server devices can be used instead of the one server device 24. In such other embodiments each of the plural server devices are specifically configured for and optimized executing one, or more than one, of the steps of Method 100.

Table 12 illustrates an exemplary trade window that displays information about a current day's trades using another one of the plural second data streams of Method 100 related to cash and futures pricing.

TABLE 12

| Desc. | Price | Quan. | Side | Time | Facility | Type | TradeID | Price32 |
|---|---|---|---|---|---|---|---|---|
| usg | 100.4838 | 1 | Sell | 7:05:33 | A | Cash | SA43217 | 100-15.5 |
| 10Y | | | | | | | | |
| usg | 100.4838 | 1 | Sell | 11:04.18 | A | Cash | SA43217 | 100-15.5 |
| 10Y | | | | | | | | |
| usg | 10.4537 | 1 | Sell | 11:10:15 | A | Cash | BA43217 | 100-14.5 |
| 10Y | | | | | | | | |
| 10Y | 113.5313 | 1 | Sell | 17:10:43 | A/C/E | Future | 2858590 | 113-17 |
| DEC | | | | | | | | |
| 03 FT | | | | | | | | |
| 10Y | 113.5313 | 1 | Sell | 17:11:29 | A/C/E | Future | 28585090 | 113-17 |
| Dec03 | | | | | | | | |
| FT | | | | | | | | |
| 10Y | 113.5625 | 1 | Sell | 13:05:58 | A/C/E | Future | 28522090 | 113-18 |
| Dec03 | | | | | | | | |
| FT | | | | | | | | |

The information illustrated in Table 12 is exemplary only. Other types of electronic information in other formats can also be used and the invention is not limited to the electronic information displayed that is obtained from the plural second data streams.

### Security and Excryption

Devices and interfaces of the present invention include plural security and/or encryption methods for secure communications. Wireless Encryption Protocol (WEP) (also called “Wired Equivalent Privacy) is a security protocol for WiLANs defined in the IEEE 802.11b standard. WEP is cryptographic privacy algorithm, based on the Rivest Cipher 4 (RC4) encryption engine, used to provide confidentiality for 802.11l wireless data.

As is known in the art, RC4 is cipher designed by RSA Data Security, Inc. of Bedford, Mass., which can accept encryption keys of arbitrary length, and is essentially a pseudo random number generator with an output of the generator being XORed with a data stream to produce encrypted data.

One problem with WEP is that it is used at the two lowest layers of the OSI model, the physical layer and the data link layer, therefore, it does not offer end-to-end security. One another problem with WEP is that its encryption keys are static rather than dynamic. To update WEP encryption keys, an individual has to manually update a WEP key. WEP also typically uses 40-bit static keys for encryption and thus provides “weak encryption,” making a WEP device a target of hackers.

The IEEE 802.11 Working Group is working on a security upgrade for the 802.11 standard called “802.11i.” This supplemental draft standard is intended to improve WiLAN security. It describes the encrypted transmission of data between systems 802.11X WiLANs. It also defines new encryption key protocols including the Temporal Key Integrity Protocol (TKIP). The IEEE 802.11i draft standard, version 4, completed Jun. 6, 2003, is incorporated herein by reference.

The 802.11i is based on 802.1x port-based authentication for user and device authentication. The 802.11i standard includes two main developments: Wireless or WiFi Protected Access (WPA) and Robust Security Network (RSN).

WPA uses the same RC4 underlying encryption algorithm as WEP. However, WPA uses TKIP to improve security of keys used with WEP. WPA keys are derived and rotated more often than WEP keys and thus provide additional security. WPA also adds a message-integrity-check function to prevent packet forgeries.

RSN uses dynamic negotiation of authentication and selectable encryption algorithms between wireless access points and wireless devices. The authentication schemes proposed in the draft standard include Extensible Authentication Protocol (EAP). One proposed encryption algorithm is an Advanced Encryption Standard (AES) encryption algorithm.

Dynamic negotiation of authentication and encryption algorithms lets RSN evolve with the state of the art in security, adding algorithms to address new threats and continuing to provide the security necessary to protect information that WiLANs carry.

The NIST developed a new encryption standard, the Advanced Encryption Standard (AES) to keep government information secure. AES is intended to be a stronger, more efficient successor to Triple Data Encryption Standard (3DES). More information on NIST AES can be found at the URL “www.nist.gov/aes.”

As is known in the art, DES is a popular symmetric-key encryption method developed in 1975 and standardized by ANSI in 1981 as ANSI X.3.92, the contents of which are incorporated herein by reference. As is known in the art, 3DES is the encrypt-decrypt-encrypt (EDE) mode of the DES cipher algorithm. 3DES is defined in the ANSI standard, ANSI X9.52-1998, the contents of which are incorporated herein by reference. DES modes of operation are used in conjunction with the NIST Federal Information Processing Standard (FIPS) for data encryption (FIPS 46-3, October 1999), the contents of which are incorporated herein by reference.

The NIST approved a FIPS for the AES, FIPS-197. This standard specified “Rijndael” encryption as a FIPS-approved symmetric encryption algorithm that may be used by U.S. Government organizations (and others) to protect sensitive information. The NIST FIPS-197 standard (AES FIPS PUB 197, November 2001) is incorporated herein by reference.

The NIST approved a FIPS for U.S. Federal Government requirements for information technology products for sensitive but unclassified (SBU) communications. The NIST FIPS Security Requirements for Cryptographic Modules (FIPS PUB 140-2, May 2001) is incorporated herein by reference.

As is known in the art, RSA is a public key encryption system which can be used both for encrypting messages and making digital signatures. The letters RSA stand for the names of the inventors: Rivest, Shamir and Adleman. For more information on RSA, see U.S. Pat. No. 4,405,829, now expired, incorporated herein by reference.

As is known in the art, “hashing” is the transformation of a string of characters into a usually shorter fixed-length value or key that represents the original string. Hashing is used to index and retrieve items in a database because it is faster to find the item using the shorter hashed key than to find it using the original value. It is also used in many encryption algorithms.

Secure Hash Algorithm (SHA), is used for computing a secure condensed representation of a data message or a data file. When a message of any length<2⁶⁴ bits is input, the SHA-1 produces a 160-bit output called a “message digest.” The message digest can then be input to other security techniques such as encryption, a Digital Signature Algorithm (DSA) and others which generates or verifies a security mechanism for the message. SHA-512 outputs a 512-bit message digest. The Secure Hash Standard, FIPS PUB 180-1, Apr. 17, 1995, is incorporated herein by reference.

Message Digest-5 (MD-5) takes as input a message of arbitrary length and produces as output a 128-bit “message digest” of the input. The MD5 algorithm is intended for digital signature applications, where a large file must be “compressed” in a secure manner before being encrypted with a private (secret) key under a public-key cryptosystem such as RSA. The IETF RFC-1321, entitled “The MD5 Message-Digest Algorithm” is incorporated here by reference.

As is known in the art, providing a way to check the integrity of information transmitted over or stored in an unreliable medium such as a wireless network is a prime necessity in the world of open computing and communications. Mechanisms that provide such integrity check based on a secret key are called “message authentication codes” (MACS). Typically, message authentication codes are used between two parties that share a secret key in order to validate information transmitted between these parties.

Keyed Hashing for Message Authentication Codes (HMAC), is a mechanism for message authentication using cryptographic hash functions. HMAC is used with any iterative cryptographic hash function, e.g., MD5, SHA-1, SHA-512, etc. in combination with a secret shared key. The cryptographic strength of HMAC depends on the properties of the underlying hash function. The IETF RFC-2101, entitled “HMAC: Keyed-Hashing for Message Authentication” is incorporated here by reference.

As is known in the art, an Electronic Code Book (ECB) is a mode of operation for a “block cipher,” with the characteristic that each possible block of plaintext has a defined corresponding cipher text value and vice versa. In other words, the same plaintext value will always result in the same cipher text value. Electronic Code Book is used when a volume of plaintext is separated into several blocks of data, each of which is then encrypted independently of other blocks. The Electronic Code Book has the ability to support a separate encryption key for each block type.

As is known in the art, Diffie and Hellman (DH) describe several different group methods for two parties to agree upon a shared secret in such a way that the secret will be unavailable to eavesdroppers. This secret is then converted into various types of cryptographic keys. A large number of the variants of the DH method exist including ANSI X9.42. The IETF RFC-2631, entitled “Diffie-Hellman Key Agreement Method” is incorporated here by reference.

However, the present invention is not limited to the security or encryption techniques described and other security or encryption techniques can also be used.

As is known in the art, the HyperText Transport Protocol (HTTP) Secure (HTTPs), is a standard for encrypted communications on the World Wide Web. HTTPs is actually just HTTP over a Secure Sockets Layer (SSL). For more information on HTTP, see IETF RFC-2616 incorporated herein by reference.

As is known in the art, the SSL protocol is a protocol layer which may be placed between a reliable connection-oriented network layer protocol (e.g. TCP/IP) and the application protocol layer (e.g. HTTP). SSL provides for secure communication between a source and destination by allowing mutual authentication, the use of digital signatures for integrity, and encryption for privacy.

The SSL protocol is designed to support a range of choices for specific security methods used for cryptography, message digests, and digistal signatures. The security method are negotiated between the source and destingation at the start of establishing a protocol session. The SSL 2.0 protocol specification, by Kipp E. B. Hickman, 1995 is incoroporated herein by reference. More information on SSL is available at the URL See “netscape.com/eng/security/SSL_{—}2.html.”

As is known in the art, Transport Layer Security (TLS) provides communications privacy over the Internet. The protocol allows client/server applications to communicate over a transport layer (e.g., TCP) in a way that is designed to prevent eavesdropping, tampering, or message forgery. For more information on TLS see IETF RFC-2246, incorporated herein by reference.

In one embodiment, the security functionality includes Cisco Compatible EXtensions (CCX). CCX includes security specifications for makers of 802.11xx wireless LAN chips for ensuring compliance with Cisco's proprietary wireless security LAN protocols. As is known in the art, Cisco Systems, Inc. of San Jose, Calif. is supplier of networking hardware and software, including router and security products.

### Fault Tolerant Electronic Trading System

It is desirable to provide a more robust and fault tolerant electronic trading system. Such an electronic trading system includes full-mirrored redundancy.

Full Mirrored Redundancy—Full mirrored redundancy allows any single component within the system to fail without forcing users off the system or causing the trading system to fail.

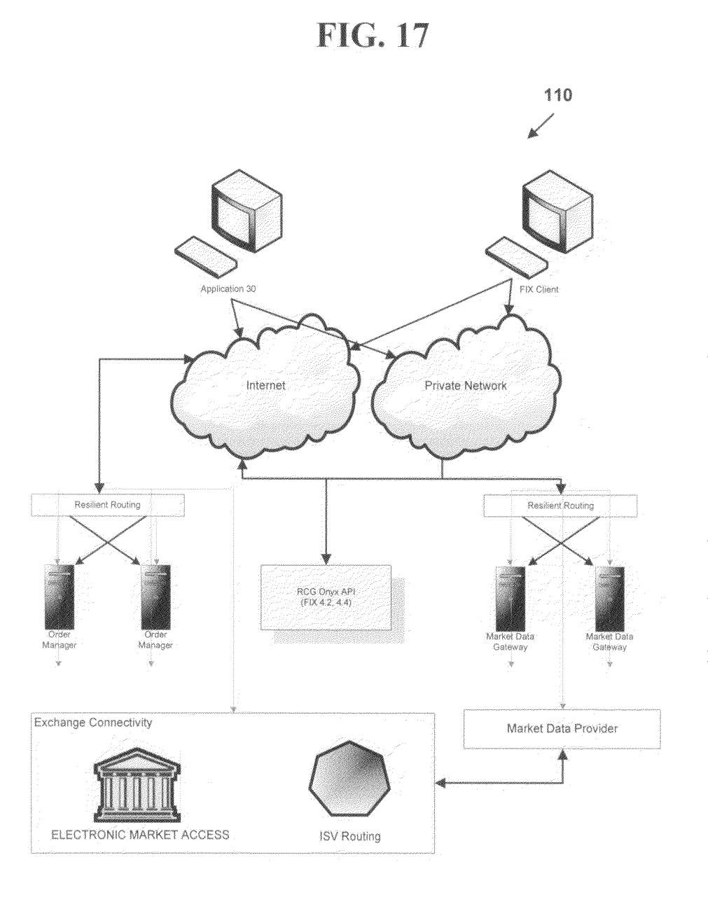

FIG. 17 is a block diagram illustrating an exemplary trading system 110.

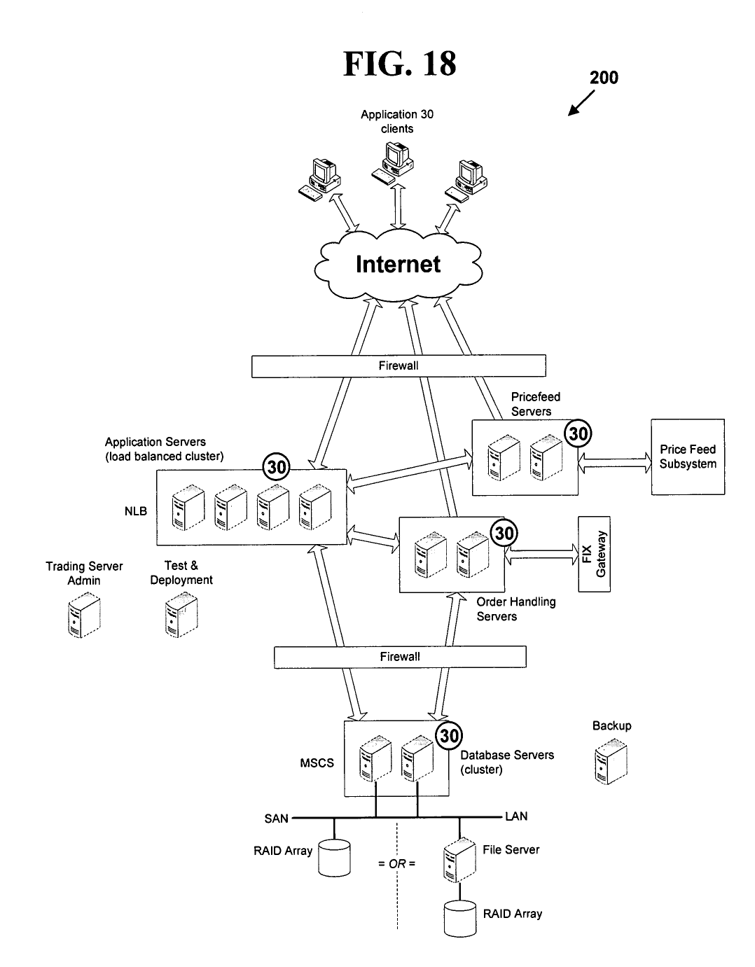

FIG. 18 is a block diagram 200 illustrating additional details of exemplary trading system 110.

The application 30 is an end-to-end redundant solution that provides access to the trading exchanges. The application 30 provides a scalable and flexible solution. Table 13 illustrates a few features of the application 30. The information illustrated in Table 13 is exemplary only. Other types of electronic information in other formats can also be used and the invention is not limited to these features.

TABLE 13

A small user interface footprint to optimize screen
“real-estate”
Intuitive user interface to minimize trader training
Custom trading window behavior to enhance display of
rapidly changing data
Synthetic order types including trailing stops, brackets,
and OCOs
Unobtrusive user notifications of trading/exchange alerts
“Sticky Windows” for manipulation of trading
screen windows
Easy import export of data to Microsoft Excel and other
spreadsheets and databases
On-line user documentation.

The application 30 provides a full feature front-end developed to meet the needs of the professional and non-professional trader and an extensible back-end available via a Financial Information Exchange (FIX) API and other APIs.

In one specific exemplary embodiment, application 30 includes a GUI 32 for target network devices 12, 14, 16 that is used under the trade name RCG ONYX. However, the invention is not limited to such an embodiment and other embodiments not including RCG ONYX can be used to practice the invention.

As is known in the art, the Financial Information Exchange (FIX) protocol is a message standard designed to facilitate the electronic exchange of securities-related information between brokerage houses, Electronic Communication Networks (ECNs), custodians, and banks. FIX was originally defined for use in supporting U.S. domestic equity trading with message traffic flowing directly between principals.

As the protocol evolved, a number of fields were added to support limited cross-border and fixed income trading. Similarly, the protocol was expanded to allow third parties to participate in the delivery of messages between trading partners. As subsequent versions of FIX are released, it is expected that functionality will continue to expand. FIX was written to be independent of any specific communications protocol or physical medium chosen for electronic data delivery. FIX supports, pre-trade, trade, post-trade, and clearing/settlement processes in the securities industries.

In application 30 a new Order Routing API is used based on the FIX API. (e.g., FIX 4.2 and 4.4, etc.). If market data is required it is available via a new Market Data API. However, market data integration is not required for order routing.

Order Routing—Order routing via FIX includes support via a secure connection. The secure connection includes a site-to-site VPN or private connection.

Order routing includes, but is not limited to, the Chicago Board of Trade (eCBOT), Chicago Mercantile Exchange (CME), and the Intercontinental Exchange (ICE Futures) to achieve the best trade performance and minimize points of failure. Electronic Market Access is also provided.

Other order routing markets include (e.g., through Independent Software Vendors (ISV)), York Mercantile Exchange (NYMEX) Access, CBOT Order Direct, Euronext LIFFE, Euronext Paris, EUREX, EUREX US, Borsa Italia (IDEM), Nymex, New York Board of Trade (NYBOT), COMEX and others.

Market Data—To achieve the ultra low latency required to meet the needs of professional traders and algorithmic trading market data is provided via a distribution capability that connects to native trading exchanges and feeds and transmits data using TCP/IP across any virtually network 18.

The application 30 also uses other APIs to manage data transmission between market data gateways and the trading application 30.

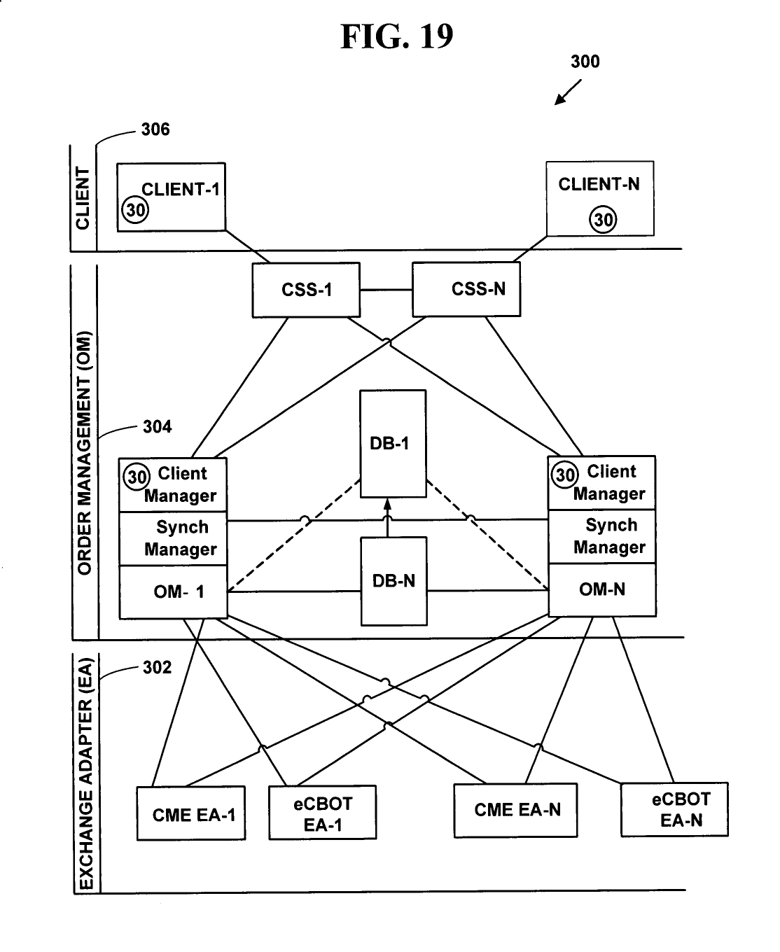

FIG. 19 is a block diagram illustrating a redundant trading system 300. FIG. 19 illustrates a fault tolerant electronic trading exchange component 302 for an electronic trading system to allow the electronic trading system to recover from a problem with one or more connections to one or more electronic trading exchanges. A fault tolerant order management component 304 for the electronic trading system allows the electronic trading system to recover from a problem with one or more connections to one or more order management systems. A fault tolerant client component 306 for the electronic trading system allows the electronic trading system to recover from a problem with one or more connections to one or more client components 30.

In one embodiment, the fault tolerant components includes a two-level (i.e., fully mirrored) redundancy that allows any single component within the system to fail without forcing users off the system or causing the trading system to fail. In another embodiment, the fault tolerant components includes an N-level redundancy that allows multiple components to fail without forcing users off the system or causing the trading system to fail or prevent any electronic trades to fail.

The redundant trading system 300 includes, but is not limited to, at least two Order Managers (OM1 and OM2) and at least two Exchange Adapters (EA) with the following characteristics as illustrated in Table 14. The information illustrated in Table 14 is exemplary only. Other types of features can also be used and the invention is not limited to these features.

TABLE 14

| | |
|---|---|
| 1. | Both OMs accept client connections through a pair of CSS′ |
| | and are load balanced by the CSS′ |
| 2. | Token based authentication/encryption is used. |
| | a. The client can fail from one OM to the other |
| | without needing to re-authenticate. |
| 3. | OMs are using some form of synchronization to mirror order |
| | state |
| 4. | 2 CME Exchange Adapters (CME EA1 and CME EA2) |
| | a. Both EAs are in an active/active group |
| | b. Both EAs are live and are using different iLink sessions |
| 5. | 2 eCBOT Exchange Adapters (eCBOT EA1 and eCBOT EA2) |
| | a. Both EAs are in an active/active group |
| | b. Both EAs are live and are using different eCBOT keys |
| 6. | Client is pulling price feed from separate ticker plant |

The redundant trading system 110 handles the following failure case scenarios illustrated in Table 15. The information illustrated in Table 15 is exemplary only. Other types of scenarios can also be used and the invention is not limited to these scenarios.

TABLE 15

| | |
|---|---|
| 1. | Exchage Adapater (EA) failure |
| | a. EA dies (Assuming EA1 for this example) |
| | i. eCBOT EA |
| | 1. Users are still able to trade through EA2 |
| | 2. Can't assume that orders are canceled through loss of |
| | connectivity because the OM can't tell whether or not the |
| | EA has died, or just lost connectivity to the OM. |
| | 3. The OM changes the order state to “unknown” |
| | a. This order state change is passed to the client as |
| | with any order state change. This could in theory |
| | allow the client to notify the user that a specific |
| | order has an issue. |
| | ii. CME EA |
| | 1. Users are still able to trade through EA2 |
| | 2. Can't assume that orders are canceled through loss of |
| | connectivity because the OM can't tell whether or not the |
| | EA has died, or just lost connectivity to the OM. |
| | 3. The OM changes the order state to “unknown” |
| | a. This order state change is passed to the client as |
| | with any order state change. This could in theory |
| | allow the client to notify the user that a specific |
| | order has an issue. |
| | b. EA loses connectivity to the exchange, but retains |
| | connectivity to the OM(s) |
| | i. Exchange specific behavior regarding order states |
| | 1. Examples: |
| | a. CME-Working orders are placed into an |
| | “Unknown” state, since they are still working on the |
| | exchange, but we cannot access them any more. |
| | b. eCBOT-Working orders are placed into a |
| | “canceled” state, since on disconnection of a key, |
| | all working orders are canceled. |
| | c. EA loses connectivity to the OM(s), but retains connectivity |
| | to the exchange |
| | i. OM |
| | 1. OM places all working orders that go through that order |
| | pipe into an “Unknown” state. |
| | 2. OM ceases to use the disconnected order pipe for order |
| | routing. |
| | ii. EA |
| | 1. EA continues to work orders normally, queuing order state |
| | change information. |
| | d. EA returns to service during a session |
| | i.The OM receives updated state change information from the EA |
| | when connectivity is returned. |
| | 1. This updated state information is passed on to the clients. |
| | ii. The OM begins to use the EA as an order pipe again. |
| 2. | Order Management (OM) failure |
| | a. OM dies (total OM failure) |
| | i. Client |
| | 1. Due to the CSS, the client is automatically shifted to |
| | another OM in the same cluster |
| | a. This shift should be seamless to the end user |
| | ii. OM |
| | 1. With the open order state synchronization, the other order |
| | managers in a cluster should know about any open orders. |
| | a. There is a possibility of missing an order state |
| | update during a failure |
| | iii. EA |
| | 1. Handle orders that are in an “unknown” state with an OM |
| | failure. |
| | a. The EA could send the order state information to |
| | another OM |
| | i. Would require the OM have some idea how |
| | to deal with it. |
| | b. The EA could queue the order state for an eventual |
| | return to service of the original OM |
| | i. OM may not return. Could leave the orders |
| | in an Unknown state for a long period of |
| | time |
| | c. The EA could discard state change information for |
| | the down OM. |
| | i. This is more or less predicated on the idea |
| | that we will have to manually status these |
| | orders. |
| | 1. We will certainly need some form of |
| | administrative tool in order to |
| | facilitate this possibility. |
| | b. OM loses connectivity to some exchanges |
| | i. See EA lose of connectivity to OM |
| | c. OM loses connectivity to Synchronization channel |
| | i. Other OMs are not going to see any state updates |
| | 1. This is failover/open order monitoring. |
| | ii. The disconnected OM is not going to see other OM's order state |
| | updates. |
| | iii. Some method of dealing with a “resynchronization” |
| | is going to be needed to get all the OMs back in synch. |
| | d. OM returns to service during a session |
| | i. |
| 3. | Client 30 failure |
| | a. Client 30 loses connection |
| | i. Since the client is connected to the OMs through a layer 4 switch, |
| | this would indicate that the client has lost all connectivity to the |
| | system. In this case there is no failover possible |
| | 1. It is possible to setup switches (e.g., Cisco's CSS switches) |
| | to do load balancing from two locations and fail between |
| | them (including separate address space, etc). This might |
| | add a scenario in which we fail from one site to another. |

Server 24 with application 30 including database 24′ includes entries to provide the redundant trading system and use via the FIX APIs and other APIs. Table 16 illustrates exemplary database entries. The information illustrated in Table 16 is exemplary only. Other types of database entries can also be used and the invention is not limited to these entries.

TABLE 16

| | | | | |
|---|---|---|---|---|
| Name | Type | Len | N | Description |

tUser
The User table records OP2 Users and captures per-User constants used by the Client
application 30.
tUser

| | | | | |
|---|---|---|---|---|
| PK | UserId | rowid- | — | |
| | | ident | | |
| | Username | nvchar | 16 | Unique OP2 username. |
| | Password | nvchar | 16 | OP2 User's password. |
| | Name | nvchar | 32 | Full User name - used informationally. |
| | Prefix | char | 4 | Unique 4-char code assigned to the |
| | | | | OP2 User. |
| FK | ServerId | rowid | — | Order/Price server User is assigned |
| | | | | to. |
| | DefaultContractLimit | int | 4 | User's default lot limit (Fat Finger |
| | | | | Limit). |

tServer
The Server 24 table records a logical association between an Order Server and a Price
Server so that Users can be assigned to both Servers as one logical group instead of
individually, and so that Server reassignments can be made in one place.
The OrderServerIP and PriceServerIp fields must be internet addresses in IPv4 dot
notation.
tServer

| | | | | |
|---|---|---|---|---|
| PK | ServerId | rowid- | — | |
| | | ident | | |
| | Name | nvchar | 20 | Arbitrary name assigned to the Order + Price |
| | | | | server combination. |
| | OrderServerIp | nvchar | 15 | Order server IP address in dot notation. |
| | OrderServerPort | int | 4 | Order server port. |
| | PriceServerIp | nvchar | 15 | Price server IP address in dot notation. |
| | PriceServerPort | int | 4 | Price server port. |

tAccount
The Account table records all Accounts available for use in the OMS.
tAccount

| | | | | |
|---|---|---|---|---|
| PK | AccountId | rowid- | — | |
| | | ident | | |
| | Account | nvchar | 16 | Trading Account #. |
| | Name | nvchar | 32 | Arbitrary name of the Account. |

xtUserAccount
The UserAccount cross-ref table defines which Accounts are available to which User.
One Account should be designated as the User's default account by setting IsDefault to
true.
Note that there is no Db enforcement of a single default - the Admin front-end must
enforce this manually. We decided it was not worth the extra table to implement this
“correctly”. When the web service uses this table to return a list of Accounts for a User,
if there is more than one Account listed as default, the service may choose the default
Account arbitrarily.
xtUserAccount

| | | | | |
|---|---|---|---|---|
| PK, FK | UserId | rowid | — | FK to tUser. |
| PK, FK | AccountId | rowid | — | FK to tAccount. |
| | IsDefault | bit | 1 | True = Account is the default Account |
| | | | | for the User. |

tExchange
The Exchange table records all Exchanges recognized by the OMS.
tExchange

| | | | | |
|---|---|---|---|---|
| PK | ExchangeId | rowid- | — | |
| | | ident | | |
| | Name | nvchar | 12 | Arbitrary Exchange name. |
| | MarketIdCode | nvchar | 16 | ISO 1083 Market Identifier Code |

tExchangeUser
The ExchangeUser table is a cross-ref table that records per-User eCBOT login
information (ITMs and passwords).
tExchangeUser

| | | | | |
|---|---|---|---|---|
| PK, FK | UserId | rowid | — | FK to tUser. |
| PK, FK | ExchangeId | rowid | — | FK to tExchange. |
| | VenueUsername | nvchar | 16 | User's eCBOT ITM. |
| | VenuePassword | nvchar | 16 | User's eCBOT password. |

tExchangeData
The ExchangeData table captures Exchange-specific, per-User, per-Account data not
supplied by the Client that is needed on trade submission.
This table is a cross-ref table.
tExchangeData

| | | | | |
|---|---|---|---|---|
| PK, FK | ExchangeId | rowid | — | FK to tExchange. |
| PK, FK | UserId | rowid | — | FK to tUser. |
| PK, FK | AccountId | rowid | — | FK to tAccount. |
| | CTI | char | 1 | CTI code. |
| | Origin | char | 1 | eCBOT “Account Code” |
| | Code1 | nvchar | 16 | eCBOT “eCBOT Id” |
| | Code2 | nvchar | 16 | Not used for eCBOT. |

tRoute
The Route table defines a Route to an Exchange. There may exist several Routes to a
single Exchange (e.g., different clearing pipes).
tRoute

| | | | | |
|---|---|---|---|---|
| PK | RouteId | rowid- | — | |
| | | ident | | |
| FK | ExchangeId | rowid | — | FK to tExchange. |
| | SymbolicName | nvchar | 16 | Short arbitrary name for the Exchange |
| | | | | Route. |

xtAccountRoute
The AccountRoute cross-ref table associates Accounts with Exchange Routes.
xtAccountRoute

| | | | | |
|---|---|---|---|---|
| PK, FK | ExchangeId | rowid | — | FK to tExchange. |
| PK, FK | AccountId | rowid | — | FK to tAccount. |
| FK | RouteId | rowid | — | FK to tRoute. |

tHost
The Host table describes Host computers that can run OMS components.
tHost

| | | | | |
|---|---|---|---|---|
| PK | HostId | rowid- | — | |
| | | ident | | |
| | Address | nvchar | 32 | IP address in dot notation or DNS- |
| | | | | resolvable machine name. |

tOrderMgrGroup
The OrderMgrGroup table groups Order Managers into Failover Groups.
tOrderMgrGroup

| | | | | |
|---|---|---|---|---|
| PK | OMGroupId | rowid- | — | |
| | | ident | | |
| | Name | nvchar | 32 | Arbitrary Group name (FG - Failover |
| | | | | Group). |

tExchangeAdapterGroup
The ExchAdapterGroup table groups Exchange Adapters into Routing Groups.
tExchAdapterGroup

| | | | | |
|---|---|---|---|---|
| PK | EAGroupId | rowid- | — | |
| | | ident | | |
| | Name | nvchar | 32 | Arbitrary Group name (RG - Routing |
| | | | | Group). |
| FK | RouteId | rowid | — | Specific Route associated with the RG; |
| | | | | FK to tRoute. |

tOrderManager
The OrderManager table defines an instance of the OM service and what Host it runs on.
tOrderManager

| | | | | | |
|---|---|---|---|---|---|
| PK | OrderMgrId | rowid- | — | | |
| | | ident | | | |
| | Name | nvchar | 32 | | Arbitrary name. |
| FK | HostId | rowid | — | | Host on which to run Order Manager; |
| | | | | | FK to tHost. |
| | Port | int | 4 | | Order Manager port number. |
| FK | OMGroupId | rowid | — | N | Group membership of Order Manager; |
| | | | | | FK to tOrderMgrGroup. |

tExchangeAdapter
The ExchangeAdapter table defines an instance of an EA service and what Host it runs
on.
It also contains any global Exchange-specific data needed to communicate with the
Exchange, such as ITM & password in the case of the eCBOT.
tExchangeAdapter

| | | | | | |
|---|---|---|---|---|---|
| PK | ExchAdapterId | rowid- | — | | |
| | | ident | | | |
| | Name | nvchar | 32 | | Arbitrary name. |
| FK | ExchangeId | rowid | — | | Exchange associated with Adapter; FK |
| | | | | | to tExchange. |
| FK | HostId | rowid | — | | Host on which to run Exchange Adapter; |
| | | | | | FK to tHost. |
| | Port | int | 4 | | Exchange Adapter port number. |
| FK | EAGroupId | rowid | — | N | Group membership of Exchange |
| | | | | | Adapter; FK to tExchAdapterGroup. |
| | VenueUsername | nvchar | 16 | | Optional venue-specific usename. |
| | VenuePassword | nvchar | 16 | | Optional venue-specific password. |

tInstrumentClass
The InstrumentClass table records data concerning a class of tradeable entities (e.g., a
futures contract).
tInstrumentClass

| | | | | | |
|---|---|---|---|---|---|
| PK | InstClassId | rowid- | — | | |
| | | ident | | | |
| FK | ExchangeId | rowid | — | | FK to tExchange. |
| | Name | nvchar | 64 | N | Long name/description. |
| | ShortName | nvchar | 16 | N | Short name for Client display. |
| | Symbol | nvchar | 16 | | Identifying symbol for the class. |
| FK | SpecId | rowid | — | | Quote specification for the class; FK to |
| | | | | | tPriceSpec. |

tInstrument
The Instrument table records individual tradeable entities.
For futures, tradeable entities comprise a contract plus an expiry date. The contract
defines the item being traded and the quote specification, among other things.
tInstrument

| | | | | | |
|---|---|---|---|---|---|
| PK | InstrumentId | rowid- | — | | |
| | | ident | | | |
| FK | InstClassId | rowid | — | | FK to tInstrumentClass. |
| | ExchStr | nvchar | 32 | N | eCBOT AMR string; TEMPORARY |
| | | | | | FIELD - WILL BE REMOVED. |
| | ExchInstId | int | 4 | N | Placeholder field; MAY BE REMOVED. |
| | ExpiryDate | int | 4 | N | Optional expiry date. Format is |
| | | | | | YYMMDD; if day is not used (i.e., the |
| | | | | | expiry specifies a month), set it to 0. |

tPriceSpec
The PriceSpec table records the OP2 price specification for a specific Instrument class
(e.g., contract).
tPriceSpec

| | | | | |
|---|---|---|---|---|
| PK | SpecId | rowid- | — | |
| | | ident | | |
| | Name | nvchar | 32 | Arbitrary name. |
| | TickNumerator | int | 4 | OP2 defined tick numerator. |
| | TickDenominator | int | 4 | OP2 defined tick denominator. |

tExchPriceSpec
The ExchPriceSpec table records any constants that are necessary to convert between the
OP2 price format and an Exchange-specific price format.
tExchPriceSpec

| | | | | | |
|---|---|---|---|---|---|
| PK | ExchSpecId | rowid- | — | | |
| | | ident | | | |
| FK | ExchangeId | rowid | — | | FK to tExchange. |
| FK | SpecId | rowid | — | | FK to tPriceSpec. |
| | Const1 | int | 4 | N | Exchange-specific constant used in |
| | | | | | conversion between OP2 price format |
| | | | | | and Exchange price format. |
| | Const2 | int | 4 | N | Exchange-specific constant used in |
| | | | | | conversion between OP2 price format |
| | | | | | and Exchange price format. |

tUserData
The UserData table holds the next sequence number available to a given User for
generating Order IDs.
Each time a “block” of sequence numbers are requested by an OM, the NextSequence
number will be incremented by a configurable block amount.
tUserData

| | | | | |
|---|---|---|---|---|
| PK | Prefix | char | 4 | Unique 4-char Prefix assigned to a User. |
| | NextSequence | int | 4 | Next sequence number available to the |
| | | | | User. |

tOrder
The Order table records static Order data, which are Order fields that does not change
once the Order has been submitted to the OM (e.g., Order ID or Order submission time).
For storage of dynamic Order fields, see OrderData, below.
tOrder

| | | | | | |
|---|---|---|---|---|---|
| PK | Prefix | char | 4 | | Order Id - Prefix component. |
| PK | Sequence | int | 4 | | Order Id - Sequence component. |
| | OrderTime | datetime | 8 | N | Time the order was submitted to the |
| | | | | | Order Manager. |
| FK | ExchangeId | rowid | — | | FK to tExchange. |
| FK | InstrumentId | rowid | — | N | FK to tInstrument. NOT FULLY |
| | | | | | IMPLEMENTED IN PHASE 1. |
| FK | OrderTypeId | rowid | — | | FK to tOrderTypeMap. |
| FK | TimeInForceId | rowid | — | | FK to tTimeInForceMap. NOTE: NO |
| | | | | | EXPIRY DATE/TIME FIELD DEFINED |
| | | | | | YET. In the CME project, there is no |
| | | | | | support for TimeInForce (this field |
| | | | | | always refers to “None”). |
| | Side | char | 1 | | Order side. |
| FK | OrderDataId | rowid | — | | Reference to the most current Order field |
| | | | | | data captured in the OrderData table; FK |
| | | | | | to tOrderData. |

tOrderTypeMap
The OrderTypeMap table is a static, read-only table containing display strings for each
OrderTypeId value. Note that OrderTypeId is not an identity column.
tOrderTypeMap

| | | | | |
|---|---|---|---|---|
| PK | OrderTypeId | rowid | — | (Manual - not Identity!) |
| | Name | nvchar | 16 | Display string for Order Type. |

tTimeInForceMap
The TimeInForceMap table is a static, read-only table containing display strings for each
TimeInForceId value. Note that TimeInForceId is not an identity column.
tTimeInForceMap

| | | | | |
|---|---|---|---|---|
| PK | TimeInForceId | rowid | — | (Manual - not Identity!) |
| | Name | nvchar | 16 | Display string for Time In Force. |

tOrderData
The OrderData table records dynamic data, which are Order fields that do or can change
once the Order has been submitted to the OM (e.g., Order State). For storage of static
Order fields, see Order, above.
tOrderData

| | | | | | |
|---|---|---|---|---|---|
| PK | OrderDataId | rowid- | — | | |
| | | ident | | | |
| | Timestamp | datetime | 8 | | Timestamp for Order Data. |
| | ExchOrderIdStr | nvchar | 32 | N | Order ID returned by Exchange after |
| | | | | | Order acceptance. |
| FK | AccountId | rowid | — | N | FK to tAccount. |
| | Quantity | int | 4 | | Order lot size. |
| FK | OrderStateId | rowid | — | | Order State; FK to tOrderStateMap. |
| FK | OrderStatusId | rowid | — | | Order Status; FK to tOrderStatusMap. |
| | FailureMsg | nvchar | 64 | N | Failure/Reject message text. |
| | FailureCode | int | 4 | N | Failure/Reject code. |
| | QtyFilled | int | 4 | | Quantity filled so far. |
| | NumFills | int | 4 | | Number of fills recorded. |
| | AveragePrice | nvchar | 16 | N | Average price of the Order considering |
| | | | | | all fills. |
| | Price | nvchar | 16 | N | Limit price (only in Limit and StopLimit |
| | | | | | orders). |
| | StopPrice | nvchar | 16 | N | Stop price (only in Stop and StopLimit |
| | | | | | orders). |

tOrderStatusMap
The OrderStatusMap table is a static, read-only table containing display strings for each
OrderStatusId value. Note that OrderStatusId is not an identity column.
tOrderStatusMap

| | | | | |
|---|---|---|---|---|
| PK | OrderStatusId | rowid | — | (Manual - not Identity!) |
| | Name | nvchar | 16 | Display string for Order Status. |

xtOrderOrderData
The OrderOrderData cross-ref table records order history. Each time a field changes in
an Order and the new data is written to the OrderData table, a new row is also written to
this table.
xtOrderOrderData

| | | | | |
|---|---|---|---|---|
| PK, FK | Prefix | char | 4 | FK to tOrder. |
| PK, FK | Sequence | int | 4 | FK to tOrder. |
| PK, FK | OrderDataId | rowid | — | FK to tOrderData. |

tFill
The Fill table records fill information, surprisingly.
tFill

| | | | | | |
|---|---|---|---|---|---|
| PK, FK | Prefix | char | 4 | | FK to tOrder. |
| PK, FK | Sequence | int | 4 | | FK to tOrder. |
| PK, FK | FillTypeId | rowid | — | | FK to tFillTypeMap. |
| PK | FillSequence | int | 4 | | OP2 sequence number of fill. |
| FK | InstrumentId | rowid | — | N | FK to tInstrument. NOTFULLY |
| | | | | | IMPLEMENTED IN PHASE 1. |
| FK | AccountId | rowid | — | | FK to tAccount. |
| | ExchFillTime | datetime | 8 | | Fill time reported by Exchange. |
| | ExchFillIdStr | nvchar | 32 | | Fill ID assigned by Exchange. |
| | Side | char | 1 | | Fill side (may differ from order side for |
| | | | | | strategy order fills). |
| | Quantity | int | 4 | | Filled quantity. |
| | Residual | int | 4 | | Quantity remaining open for the order |
| | | | | | (residual volume). |
| | Price | nvchar | 16 | | Fill price. |
| FK | FillStatusId | rowid | — | | FK to tFillStatusMap. |
| | Leg | int | 4 | N | Leg index for strategy fills. NOT |
| | | | | | IMPLEMENTED IN THE CME |
| | | | | | PROJECT. |

tFillTypeMap
The FillTypeMap table is a static, read-only table containing display strings for each
FillTypeId value. Note that FillTypeId is not an identity column.
tFillTypeMap

| | | | | |
|---|---|---|---|---|
| PK | FillTypeId | rowid | — | (Manual - not Identity!) |
| | Name | nvchar | 16 | Display string for Fill Type. |

tFillStatusMap
The FillStatusMap table is a static, read-only table containing display strings for each
FillStatusId value. Note that FillStatusId is not an identity column.
tFillStatusMap

| | | | | |
|---|---|---|---|---|
| PK | FillStatusId | rowid | — | (Manual - not Identity!) |
| | Name | nvchar | 16 | Display string for Fill Status. |

xtOMOrder
The OMOrder table tracks which Order Manager is responsible for which Order to
facilitate collection of affected Order lists during an OM outage. When an OM creates a
new Order it writes a row to OMOrder.
This table is not intended to be archived. Its information is useful only during the course
of a trading day (though perhaps longer once the GTC Time In Force type is
implemented), or more specifically, only while an OM has working orders outstanding.
xtOMOrder

| | | | | |
|---|---|---|---|---|
| PK, FK | Prefix | char | 4 | FK to tOrder. |
| PK, FK | Sequence | int | 4 | FK to tOrder. |
| FK | OrderMgrId | rowid | — | FK to tOrderManager. |

xtEAOrder
The EAOrder table tracks which Exchange Adapter is responsible for which Order to
facilitate collection of affected Order lists during an EA or Exchange outage. When an
EA accepts a new Order it writes a row to EAOrder.
See OMOrder, above, for data lifetime information.
xtEAOrder

| | | | | |
|---|---|---|---|---|
| PK, FK | Prefix | char | 4 | FK to tOrder. |
| PK, FK | Sequence | int | 4 | FK to tOrder. |
| FK | ExchAdapterId | rowid | — | FK to tExchangeAdapter. |

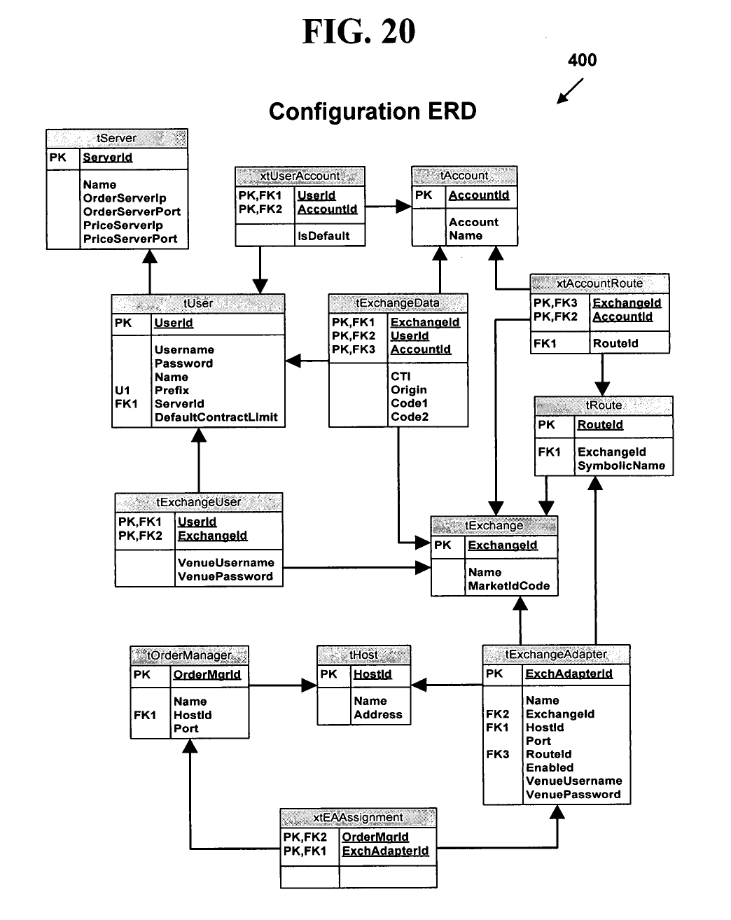

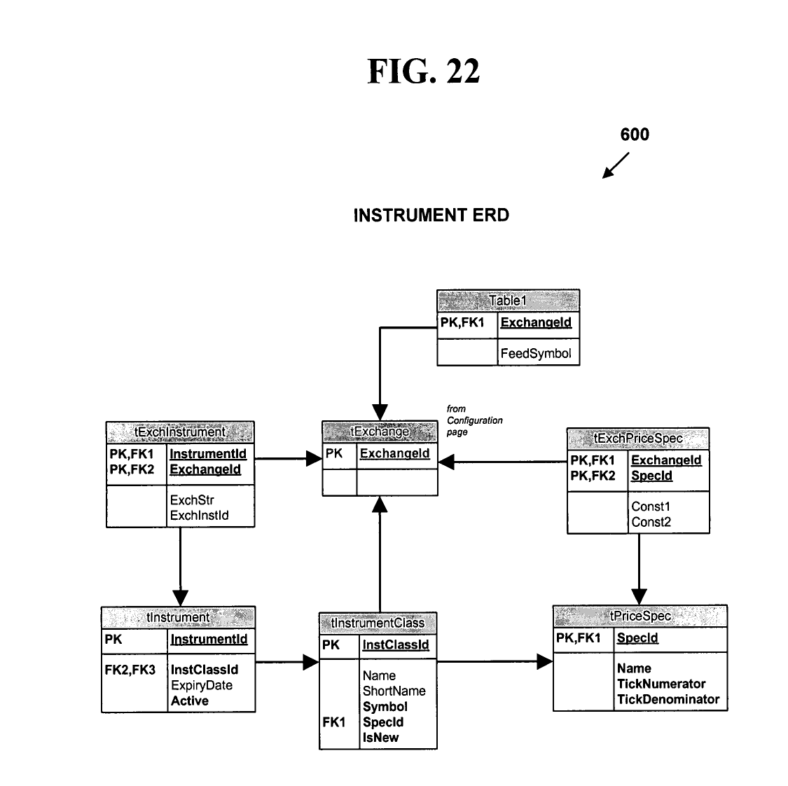

As is known in the art, an Entity Relationship Diagram (ERD) is diagram that pictorially represents entities, the relationships between them and the attributes used to describe them. FIGS. 20-22 include ERDs for the information in Table 16.

FIG. 20 is a block diagram illustrating an exemplary configuration ERD 400.

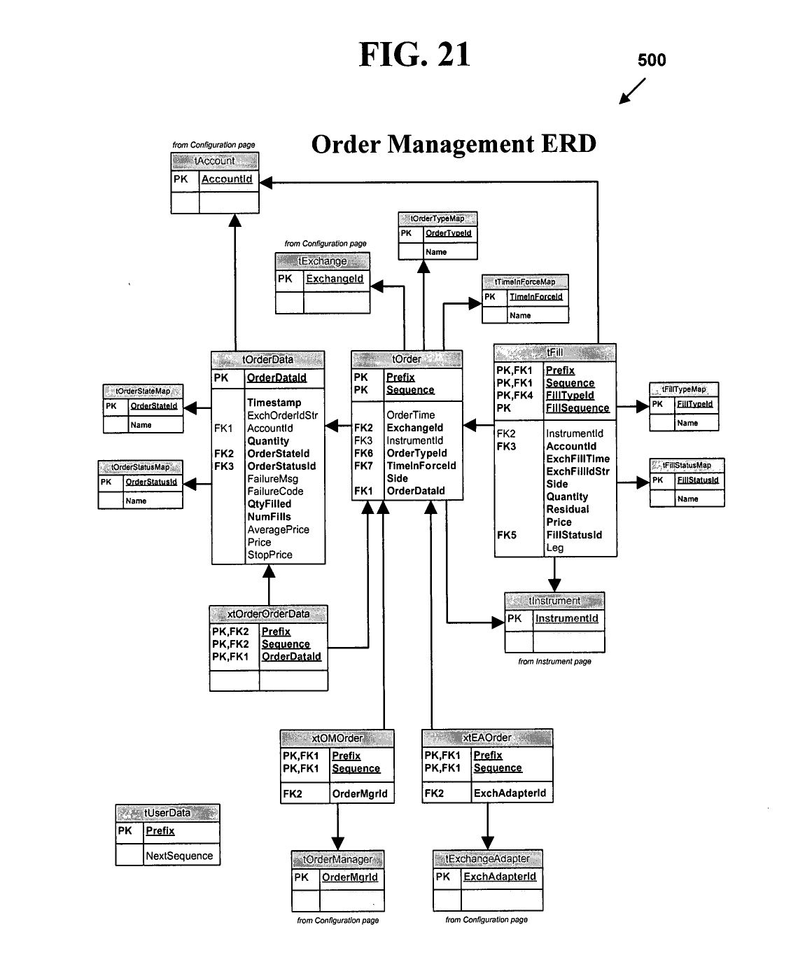

FIG. 21 is a block diagram illustrating an exemplary order management ERD 500.

FIG. 21 is a block diagram illustrating an exemplary instrument ERD 600.

Table 17 illustrates a new exemplary FIX protocol message used with the redundant trading system. The information illustrated in Table 17 is exemplary only. Other types of protocol message layouts can also be used and the invention is not limited to this protocol message layout.

TABLE 17
FIX Message = NewOrderSingle (MsgType = D)
OM >> EA

| | | | OP2 | |
|---|---|---|---|---|
| Field # | Field | FIX Req? | Req? | Description |
| 11 | ClOrdID | Y | Y | OnyxPro OrderId |
| 60 | TransactTime | Y | Y | Time Order was accepted by OM |
| 50 | SenderSubID | n | Y | UserId (_owed) |
| 1 | Account | n | Y | AccountId (_owed) |
| 55 | Symbol | Y | Y | Instrument class Symbol; informative use |
| 48 | SecurityID | n | Y | InstrumentId (_owed) |
| 54 | Side | Y | Y | Side |
| 38 | OrderQty | n | Y | Quantity |
| 59 | TimeInForce | n | n | TIF, absence indicates Day Order |
| 40 | OrdType | Y | Y | Order Type |
| | | | | Limit Price, required by Limit, StopLimit |
| 44 | Price | C | C | Order types |
| 10044 | PriceCode | n | Y | Limit Price in Onyx format |
| | | | | Stop Price, required by Stop, StopLimit |
| 99 | StopPx | C | C | Order types |
| 10099 | StopPxCode | n | Y | Stop Price in Onyx format |

Supported OrdType values:
1 - Market
2 - Limit
(3 - Stop) - later phases
(4 - Stop Limit) - later phases
Supported TimeInForce values.
0 - Day/Session

### Fault Tolerant Risk Management Controls

Application 30 also in the redundant mode also operates under pre-trade risk and post-trade risk controls. Post-trade (or “soft”) controls are also used as an additional risk-management tool. These controls are set, maintained and monitored by a Risk Management application.

Pre-Trade Controls—Pre-trade controls are set via a Pre-Trade Risk Management System for all clients who execute via an electronic solution. Once established, clients cannot exceed their pre-trade control limits. If clients enter orders that would breach any of the pre-trade limits, they will receive a rejection message and code as part of a FIX execution report (e.g., message type 8.) Clients can then call a help desk or use an eHelp application for an explanation or resolution.

Pre-trade controls may also be set on the basis of client or account number, market or product type, order type, and/or trading identifier. At each of these control levels, additional controls can also be established—by order size (to mitigate “fat finger” risk), open position limits (max long or short) and/or buying power limits.

Post-Trade Controls Post-trade controls are also set for all electronic trading clients in via a Post-Trade System that monitors a client's overall trading activity intraday and interday. Limit breaches are identified in real-time by comparing clients' initial margin requirements with their daily exposure limit. Once established, any limit breaches are identified in real-time, and the Risk Management System will then contact the affected client. Types of Post-Trade Controls & Monitoring, includes, but is not limited to (1) Open Position Limit; (2) Daily P&L Limit; (3) Excess Cash Limit; and (4) Cash Available.

### Method for Fault Tolerant Electronic Trading

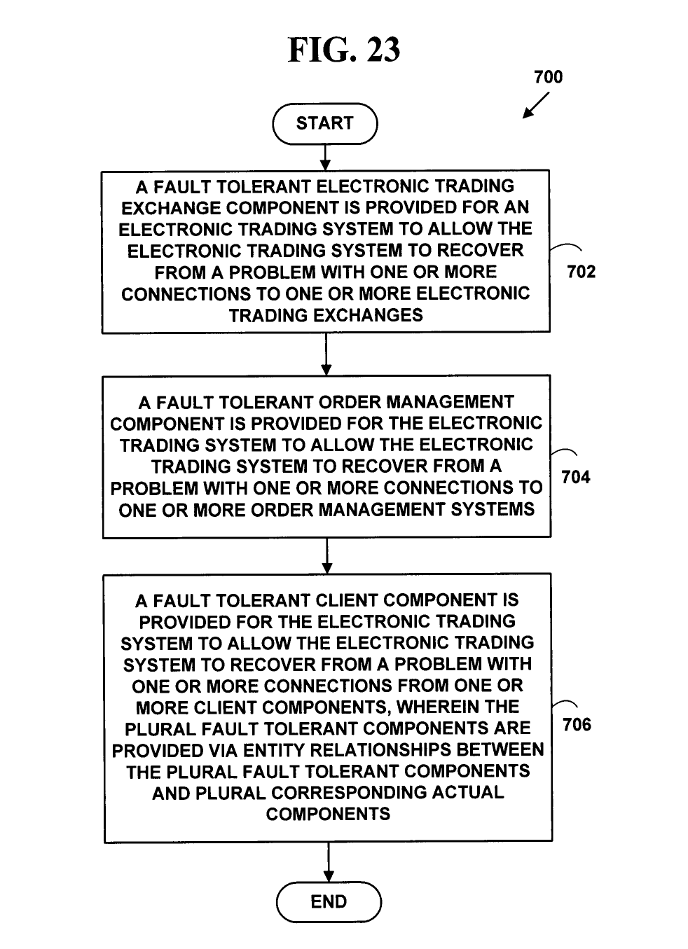

FIG. 23 is a flow diagram illustrating a Method 700 for fault tolerant electronic trading. Step 702, a fault tolerant electronic trading exchange component is provided for an electronic trading system to allow the electronic trading system to recover from a problem with one or more connections to one or more electronic trading exchanges. At Step 704, a fault tolerant order management component is provided for the electronic trading system to allow the electronic trading system to recover from a problem with one or more connections to one or more order management systems. At Step 706, a fault tolerant client component is provided for the electronic trading system to allow the electronic trading system to recover from a problem with one or more connections from one or more client components. The plural fault tolerant components are provided via entity relationships between the plural fault tolerant components and plural corresponding actual components.

Method 700 is illustrated with an exemplary embodiment. However, the invention is not limited to this embodiment and other embodiments can also be used to practice the invention.

In such an exemplary embodiment at Step 702 a fault tolerant electronic trading exchange component 302 is provided for an electronic trading system to allow the electronic trading system to recover from a problem with one or more connections 31, 33 to one or more electronic trading exchanges 20, 22.

At Step 704, a fault tolerant order management component 304 is provided for the electronic trading system to allow the electronic trading system to recover from a problem with one or more connections to one or more order management systems.

At Step 706, a fault tolerant client component 306 is provided for the electronic trading system to allow the electronic trading system to recover from a problem with one or more connections from one or more client components 30. The plural fault tolerant components are provided via entity relationships 400, 500, 600 between the plural fault tolerant components and plural corresponding actual components.

In one exemplary embodiment, the plural fault tolerant components 302, 304 and 306 and the plural corresponding actual components communicate via the FIX protocol. The plural entity relationships include a configuration entity relationship 400, an order management entity relationship 500 and an instrument entity relationship 600. The plural fault tolerant components include the pre-trade risk and post-trade risk controls described above.

In one embodiment, the fault tolerant components 302, 304, 306 communicate with secure communications paths. In one embodiment, the secure communications paths include using SSL-based communications.

### Method for Fault Tolerant Electronic Trading with Risk Management Controls.

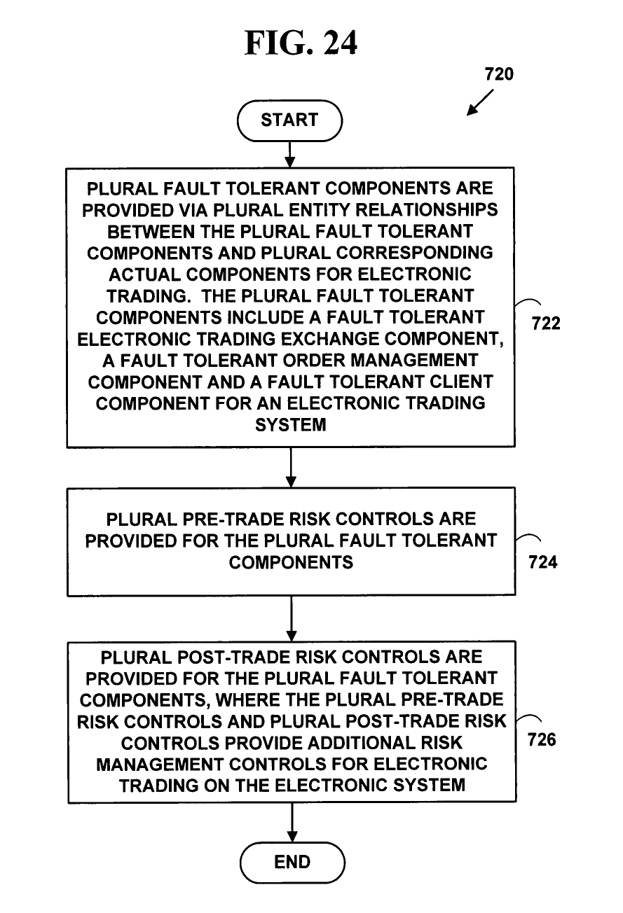

FIG. 24 is a flow diagram illustrating a Method 720 for fault tolerant electronic trading with risk management controls. At Step 722, plural fault tolerant components are provided via plural entity relationships between the plural fault tolerant components and plural corresponding actual components for electronic trading. The plural fault tolerant components include a fault tolerant electronic trading exchange component, a fault tolerant order management component and a fault tolerant client component for an electronic trading system. At Step 724, plural pre-trade risk controls are provided for the plural fault tolerant components. At Step 726, plural post-trade risk controls are provided for the plural fault tolerant components. The plural pre-trade risk controls and plural post-trade risk controls provide additional risk management controls for electronic trading on the electronic system.

Method 720 is illustrated with an exemplary embodiment. However, the invention is not limited to this embodiment and other embodiments can also be used to practice the invention.

In such an exemplary embodiment at Step 722, plural fault tolerant components 302, 304, 306 are provided via plural entity relationships 400, 500, 600 between the plural fault tolerant components and plural corresponding actual components for electronic trading. The plural fault tolerant components include a fault tolerant electronic trading exchange component 302, a fault tolerant order management component 304 and a fault tolerant client component 306 for an electronic trading system.

At Step 724, plural pre-trade risk controls described above are provided for the plural fault tolerant components.

At Step 726, plural post-trade risk controls described above are provided for the plural fault tolerant components.

The plural pre-trade risk controls and plural post-trade risk controls provide additional risk management controls for electronic trading on the electronic system.

It should be understood that the architecture, programs, processes, methods and It should be understood that the architecture, programs, processes, methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

We claim:

1. A method for fault tolerant electronic trading, comprising:
providing a fault tolerant electronic trading exchange component for an electronic trading system to allow the electronic trading system to recover from a problem with one or more connections to one or more electronic trading exchanges;
providing a fault tolerant order management component for the electronic trading system to allow the electronic trading system to recover from a problem with one or more connections to one or more order management systems; and
providing a fault tolerant client component for the electronic trading system to allow the electronic trading system to recover from a problem with one or more connections to one or more client components,
wherein the plurality of fault tolerant components are provided via a plurality of entity relationships between the plurality of fault tolerant components and plurality of corresponding actual components.

2. The method of claim 1 further comprising a computer readable medium having stored therein instructions for causing one or more processors to execute the steps of the method.

3. The method of claim 1 wherein the plurality of fault tolerant components and the plurality of corresponding actual components communicate via Financial Information Exchange (FIX) protocol.

4. The method of claim 1 wherein the plurality of entity relationships include a configuration entity relationship, an order management entity relationship and an instrument entity relationship.

5. The method of claim 1 wherein the plurality of fault tolerant components includes a plurality of risk management controls including a pre-trade risk controls and post-trade risk controls.

6. The method of claim 5 wherein the pre-trade risk controls include client number, account number, market or product type, order type or trading identifier.

7. The method claim 5 wherein the post-trade risk controls include open position limit, daily profit and loss limit, excess cash limit or cash available.

8. The method of claim 1 wherein the plurality of fault tolerant components communicate with secure communications paths.

9. The method of claim 1 wherein the plurality of fault tolerant components include N-level redundancy that allows multiple components to fail on the electronic trading system without affecting electronic trades on the electronic trading system.

10. A method for fault tolerant electronic trading with risk management controls, comprising:
providing a plurality of fault tolerant components via a plurality of entity relationships between the plurality of fault tolerant components and plurality of corresponding actual components for electronic trading, wherein the plurality of fault tolerant components include a fault tolerant electronic trading exchange component, a fault tolerant order management component and a fault tolerant client component for an electronic trading system;
providing a plurality of pre-trade risk controls for the plurality of fault tolerant components;
providing a plurality of post-trade risk controls for the plurality of fault tolerant components,
wherein the plurality of pre-trade risk controls and the plurality of post-trade risk controls providing additional risk controls for electronic trading on the electronic system.

11. The method of claim 10 further comprising a computer readable medium having stored therein instructions for causing one or more processors to execute the steps of the method.

12. The method of claim 10 wherein the pre-trade risk controls include client number, account number, market or product type, order type or trading identifier.

13. The method claim 10 wherein the post-trade risk controls include open position limit, daily profit and loss limit, excess cash limit or cash available.

14. The method of claim 10 wherein the plurality of fault tolerant components include N-level redundancy that allows multiple components to fail on the electronic trading system without affecting electronic trades on the electronic trading system.

15. The method of claim 10 wherein the plurality of fault tolerant components and a plurality of corresponding actual components communicate via Financial Information Exchange (FIX) protocol.

16. The method of claim 10 wherein the plurality of entity relationships include a configuration entity relationship, an order management entity relationship and an instrument entity relationship.

17. A fault tolerant system for electronic trading, comprising in combination:
means for providing fault tolerance including a means for a fault tolerant electronic trading exchange component for an electronic trading system to allow the electronic trading system to recover from a problem with one or more connections to one or more electronic trading exchanges, for providing a fault tolerant order management component for the electronic trading system to allow the electronic trading system to recover from a problem with one or more connections to one or more order management systems, and for providing a fault tolerant client component for the electronic trading system to allow the electronic trading system to recover from a problem with one or more connections to one or more client components, wherein the plurality of fault tolerant components are provided via a plurality of entity relationships between the plurality of fault tolerant components and plurality of corresponding actual components; and
means for pre-trade risk controls wherein a client device cannot exceed pre-determined pre-trade control limits; and
means for post-trade risk controls where a client device cannot exceed pre-determined post-trade control limits.

18. The system of claim 17 wherein the plurality fault tolerant components and the plurality of corresponding actual components communicate via Financial Information Exchange (FIX) protocol.

19. The system of claim 17 wherein the plurality of entity relationships include a configuration entity relationship, an order management entity relationship and an instrument entity relationship.

20. The system of claim 17 wherein the means for pre-trade risk controls include client number, account number, market or product type, order type or trading identifier.

21. The method claim 17 wherein the means for post-trade risk controls include open position limit, daily profit and loss limit, excess cash limit or cash available.
